(19) United States
(12) Patent Application Publication
(10) Pub. No.: US 2026/0264108 A1
(43) Pub. Date: Sep. 10, 2026

(54) VIBRATION CONTROL APPARATUS, VIBRATION CONTROL METHOD, CONTROL SYSTEM, AND VIBRATION APPARATUS

(71) Applicant: Sony Group Corporation, Tokyo (JP)

(72) Inventors: Tatsuya Yamazaki, Kanagawa (JP); Koji Nagata, Tokyo (JP); Tetsugoro Ihara, Tokyo (JP); Naoki Morikawa, Tokyo (JP)

(73) Assignee: Sony Group Corporation, Tokyo (JP)

(21) Appl. No.: 19/164,289

(22) PCT Filed: Feb. 7, 2024
(86) PCT No.: PCT/JP2024/003995

§ 371 Date: Sep. 11, 2025

(30) Foreign Application Priority Data
Mar. 22, 2023 (JP) 2023-045989

(51) Int. Cl. B06B 1/02; A63J 5/00; A63J 25/00

(52) U.S. Cl. CPC B06B 1/0246; A63J 5/00; A63J 25/00; A63J 2005/002

(57) ABSTRACT

A vibration control apparatus includes: a vibration signal selection unit that selects a target vibration signal that is a target vibration waveform; and a drive signal generation unit that generates a drive signal to be output to a vibration apparatus in order for the vibration apparatus that comes into contact with a vehicle and vibrates the vehicle from outside to vibrate the vehicle with the target vibration signal, obtains a vehicle body vibration signal that is a vibration signal of the vehicle vibrated by the vibration apparatus, generates an adjustment vibration signal for making the vehicle body vibration signal coincide with the target vibration signal, and updates the drive signal on the basis of the adjustment vibration signal so that the vibration apparatus vibrates the vehicle with the target vibration signal.

### TECHNICAL FIELD

The present disclosure relates to a vibration apparatus that comes into contact with a vehicle and vibrates the vehicle from outside and to a vibration control apparatus, a vibration control method, and a control system that control the vibration apparatus.

### BACKGROUND ART

One idea for improving the quality of entertainment experiences is to vibrate seats.

For example, in movie theaters, services that add vibration and shaking to seats while watching a movie are provided in order to provide a more realistic experience. Moreover, headphones that vibrate while reproducing auditory content have been proposed (Patent Literature 1).

### CITATION LIST

### Patent Literature

Patent Literature 1: Japanese Patent Application Laid-open No. 2009-177574

### DISCLOSURE OF INVENTION

### Technical Problem

However, if vibration is added to seats in a movie theater, the place where the vibration can be obtained is only the movie theater, so the obtained sense of presence is limited.

In view of the above-mentioned circumstances, it is desirable to simply and conveniently control the vehicle vibration in order to obtain a further sense of presence, and even in various places and conditions.

### Solution to Problem

A vibration control apparatus according to an embodiment of the present disclosure includes:
a vibration signal selection unit that selects a target vibration signal that is a target vibration waveform; and
a drive signal generation unit that
   generates a drive signal to be output to a vibration apparatus in order for the vibration apparatus that comes into contact with a vehicle and vibrates the vehicle from outside to vibrate the vehicle with the target vibration signal,
   obtains a vehicle body vibration signal that is a vibration signal of the vehicle vibrated by the vibration apparatus,
   generates an adjustment vibration signal for making the vehicle body vibration signal coincide with the target vibration signal, and
   updates the drive signal on the basis of the adjustment vibration signal so that the vibration apparatus vibrates the vehicle with the target vibration signal.

In the present embodiment, the vibration control apparatus feeds back an actual vehicle body vibration signal of the vehicle vibrated by the vibration apparatus and generates an adjustment vibration signal on the basis of the target vibration signal and the vehicle body vibration signal. The vibration control apparatus updates the drive signal on the basis of the adjustment vibration signal. Accordingly, the vibration apparatus is capable of vibrating the vehicle with the target vibration signal. Accordingly, a suitable vibration can be applied to a passenger of the vehicle, and the user experience is improved.

The vibration signal selection unit may select the target vibration signal in accordance with audiovisual content viewed by a passenger of the vehicle.

In this manner, by selecting the target vibration signal in accordance with the audiovisual content, it is possible to apply vibration for the audiovisual content to the passenger of the vehicle, and the user experience is improved.

The vibration signal selection unit may select, as the target vibration signal, any one of
a vibration signal generated on the basis of a video signal of the audiovisual content,
a vibration signal generated on the basis of an audio signal of the audiovisual content,
a vibration signal associated with the audiovisual content, or
a preset vibration signal not depending on the audiovisual content.

In this manner, by selecting various types of target vibration signals in accordance with the audiovisual content, it is possible to apply vibration more suitable for the audiovisual content to the passenger of the vehicle, and the user experience is further improved.

The vibration signal selection unit may select, as the target vibration signal, a single preset vibration signal selected from a plurality of preset vibration signals on the basis of a genre of the audiovisual content.

Accordingly, even in a case of selecting a preset vibration signal not depending on the audiovisual content, it is possible to select a preset vibration signal relatively suitable for the audiovisual content, and it is expected that the user will be able to immerse themselves in the audiovisual content without feeling any discomfort when viewing it.

The vibration control apparatus may further include a safety management unit that stops the vibration apparatus when detecting rotation of a rear wheel of the vehicle or open of a door.

Accordingly, even in a charging station or parking area where the passenger can get in and out of the vehicle or a pedestrian can be present, it is possible to secure safety and improve the user experience.

The vibration control apparatus may further include a displacement measurement device that measures a displacement amount of the vehicle vibrated, in which
the drive signal generation unit may obtain the vehicle body vibration signal based on the displacement amount.

Accordingly, it is possible to suitably generate an adjustment vibration signal based on the vehicle body vibration signal.

The vibration control apparatus may further include the vibration apparatus.

The vibration control apparatus and the vibration apparatus may be distributed in a plurality of apparatuses and independently communicate with one another or may be incorporated in a single apparatus (vibration control apparatus).

The vibration apparatus may be installed at a stop position of the vehicle and rotate a front wheel while restricting a movement of the vehicle due to rotation of the front wheel of the vehicle, thereby vibrating the vehicle.

Tires are points where the vehicle is in contact with another object (typically, a road surface), and adding to vibration to them poses the least risk of causing a functional or visual damage. When the handbrake is applied, the rear wheels are locked, but the front wheels can rotate freely. In view of this, in the present embodiment, installed-type vibration apparatuses 510 come into contact with and press points of the front wheels, which are not in contact with the ground, inducing vibration to a vehicle.

The vibration apparatus may include
a stopper that restricts a movement in a single direction of the front wheel of the vehicle,
a pushing unit that pushes the front wheel whose movement in the single direction is restricted in the single direction, thereby rotating the front wheel to vibrate the vehicle, and
an actuator that drives the pushing unit.

Accordingly, it is possible to vibrate the vehicle and make the passenger feel the vibration with as little energy as possible and without causing damage to the vehicle body (tire wear).

The vibration apparatus may vibrate a jack-up point of the vehicle.

Accordingly, it is possible to vibrate the vehicle and make the passenger feel the vibration with as little energy as possible and without causing damage to the vehicle body (scratches on the body).

The vibration apparatus may be a self-propelled-type vibration apparatus including
an image sensor,
a self-propelled mechanism,
an actuator, and
a driving unit that
   detects a vibration point from a sensing result of the image sensor,
   controls the self-propelled mechanism in order to move by its own power to a vibration position for vibrating the detected vibration point, and
   controls the actuator to vibrate the vibration point from the vibration position.

The size and body frame structure of the vehicle, such as the vehicle width and wheelbase, differ depending on the vehicle type. By configuring the self-propelled-type vibration apparatus, it is possible to absorb these differences of the vehicle in order to support a wide variety of vehicles at a charging station.

A vibration control method according to an embodiment of the present disclosure includes:
selecting a target vibration signal that is a target vibration waveform;
generating a drive signal to be output to a vibration apparatus in order for the vibration apparatus that comes into contact with a vehicle and vibrating the vehicle from outside to vibrate the vehicle with the target vibration signal;
obtaining a vehicle body vibration signal that is a vibration signal of the vehicle vibrated by the vibration apparatus;
generating an adjustment vibration signal for making the vehicle body vibration signal coincide with the target vibration signal; and
updating the drive signal on the basis of the adjustment vibration signal so that the vibration apparatus vibrates the vehicle with the target vibration signal.

A control system according to an embodiment of the present disclosure includes:
a vibration apparatus that comes into contact with a vehicle and vibrates the vehicle from outside; and
a vibration control apparatus including
   a vibration signal selection unit that selects a target vibration signal that is a target vibration waveform, and
   a drive signal generation unit that
      generates a drive signal to be output to a vibration apparatus in order for the vibration apparatus to vibrate the vehicle with the target vibration signal,
      obtains a vehicle body vibration signal that is a vibration signal of the vehicle vibrated by the vibration apparatus,
      generates an adjustment vibration signal for making the vehicle body vibration signal coincide with the target vibration signal, and
      updates the drive signal on the basis of the adjustment vibration signal so that the vibration apparatus vibrates the vehicle with the target vibration signal.

The control system may further include
a content reproduction apparatus that reproduces audiovisual content and outputs the audiovisual content to a content output apparatus by which a passenger of the vehicle is capable of viewing the audiovisual content, in which
the vibration control apparatus may control the vibration apparatus so that the vibration apparatus vibrates the vehicle while the content reproduction apparatus is reproducing the audiovisual content.

The control system may further include
charging equipment of an electric vehicle that is the vehicle, in which
the vibration control apparatus may control the vibration apparatus so that the vibration apparatus vibrates the vehicle while charging the vehicle from the charging equipment.

A vibration apparatus according to an embodiment of the present disclosure is controlled by a vibration control apparatus including
a vibration signal selection unit that selects a target vibration signal that is a target vibration waveform, and
a drive signal generation unit that
   generates a drive signal to be output to a vibration apparatus in order for the vibration apparatus that comes into contact with a vehicle and vibrates the vehicle from outside to vibrate the vehicle with the target vibration signal,
   obtains a vehicle body vibration signal that is a vibration signal of the vehicle vibrated by the vibration apparatus,
   generates an adjustment vibration signal for making the vehicle body vibration signal coincide with the target vibration signal, and
   updates the drive signal on the basis of the adjustment vibration signal so that the vibration apparatus vibrates the vehicle with the target vibration signal.

### BRIEF DESCRIPTION OF DRAWINGS

FIG. 1 shows the summary of a control system according to an embodiment of the present disclosure.

FIG. 2 shows a configuration example of an internal media solution.

FIG. 3 shows a configuration example of an external media solution.

FIG. 4 is a table showing a configuration example of a system of the media solution.

FIG. 5 shows a system configuration example of the media solution.

FIG. 6 is a top view showing installed-type vibration apparatuses.

FIG. 7 is a side view showing the installed-type vibration apparatuses.

FIG. 8 schematically shows an operation in which a front wheel of a vehicle is fixed to an installed-type vibration apparatus.

FIG. 9 schematically shows an operation in which the installed-type vibration apparatus vibrates the front wheel of the vehicle.

FIG. 10 schematically shows a first modified example of the installed-type vibration apparatus.

FIG. 11 schematically shows a second modified example of the installed-type vibration apparatus.

FIG. 12 schematically shows a third modified example of the installed-type vibration apparatus.

FIG. 13 schematically shows a self-propelled-type vibration apparatus.

FIG. 14 shows an example of a control system configuration in which an installed-type vibration apparatus is utilized.

FIG. 15 shows an operation flow of a control system in which the installed-type vibration apparatus is utilized.

FIG. 16 shows a functional configuration of a vehicle position determination device.

FIG. 17 shows an operation flow of the vehicle position determination device.

FIG. 18 schematically shows an example of a stop position.

FIG. 19 shows a functional configuration of the safety management unit.

FIG. 20 shows an operation flow of the safety management unit.

FIG. 21 shows an operation flow of a vibration signal selection unit.

FIG. 22 schematically shows an operation of a video vibration signal generation unit.

FIG. 23 schematically shows a preset vibration signal.

FIG. 24 shows operations of a drive signal generation unit and the surroundings.

FIG. 25 is a conceptual diagram of vibration control.

FIG. 26 shows a modified example of a control system configuration in which the installed-type vibration apparatus is utilized.

FIG. 27 shows an example of the control system configuration in which the self-propelled-type vibration apparatus is utilized.

FIG. 28 shows an operation flow of the control system in which the self-propelled-type vibration apparatus is utilized.

FIG. 29 shows a functional configuration of a driving unit.

FIG. 30 shows an operation flow of the driving unit.

FIG. 31 shows a modified example of a control system configuration in which the installed-type vibration apparatus is utilized.

FIG. 32 is a block diagram showing a configuration example of a vehicle control system.

FIG. 33 is a diagram showing an example of a sensing region.

### MODE(S) FOR CARRYING OUT THE INVENTION

### 1. Background

It is predicted that the transition to electric vehicles aimed at a sustainable society will progress dramatically over the next 10 years.

Incentives for popularization and investment in the development of charging infrastructure are beginning to be enacted as national policies in various countries.

However, EV chargers themselves have significant problems. Even with Level 3 EV chargers, it takes 0.5 to 3 hours to fully charge an electric vehicle. For this reason, it is difficult to simply replace the infrastructure for gasoline-powered vehicles, which can be fully refueled in a maximum of 5 minutes, with EV chargers, which take at least 30 minutes. Also considering the transition period from gasoline-powered vehicles to electric vehicles (EVs), it is thought that measures that consider traffic congestion and time-killing due to EV charging times, as well as battery deterioration (in a case where Level 3 is used in particular), are essential.

In view of this, in the present embodiment, while the EV is being charged at the EV charging station, the passenger is enabled to view audiovisual content. While the passenger is viewing the audiovisual content, vibration corresponding to the content is applied to the vehicle from the outside, to realize a realistic viewing experience. For example, while a commercially available EV vehicle is being charged, vibration linked to the content or vibration that feels pleasant is intentionally applied to the vehicle from a portion partially in contact with the outside.

Unlike technologies that place the vehicle on a dedicated vibration machine, such as 6DOF installed (e.g., a vibration machine that adds vibration in six axial directions) or technologies that intentionally apply vibration to measure the durability of the vehicle, it is desirable to adapt to various places and conditions and simply and conveniently control the vehicle vibration. Accordingly, the user will be able to spend the charging time at the EV charging station in a more enjoyable way.

It should be noted that vibrating an EV from the outside while the EV is stopped and being charged and the passenger is watching audiovisual content is just one example of a use case of the present embodiment. The present embodiment can be applied to a vehicle parked in a place other than public roads. The present embodiment can also be applied to other use cases. For example, the vehicle is not limited to the EV, and may be an internal combustion vehicle (ICV) (internal-combustion engine vehicle). For example, the present embodiment can be applied to a vehicle stopped, not charged. For example, the passenger may view either audio content or visual content or does not need to view any content.

Hereinafter, an embodiment of the present disclosure will be described with reference to the drawings.

### 2. Summary of Control System

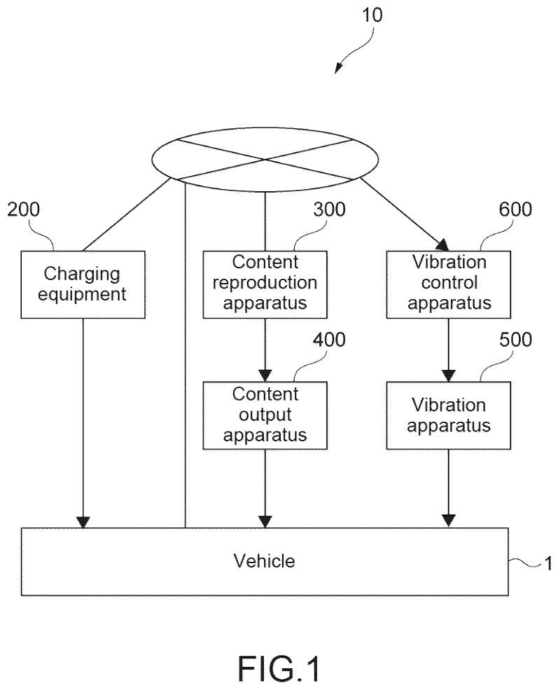

FIG. 1 shows the summary of a control system according to an embodiment of the present disclosure.

A control system 10 includes charging equipment 200, a content reproduction apparatus 300, a content output apparatus 400, a vibration apparatus 500, and a vibration control apparatus 600.

The charging equipment 200 is charging equipment for charging a vehicle 1, which is an electric vehicle (EV). The charging equipment 200 may be installed in a public parking lot, such as a restaurant, shopping mall, entertainment facility, or public facility, a parking lot that rents by the hour, or a parking lot for a residence (apartment building, single-family home).

The content reproduction apparatus 300 reproduces audiovisual content and outputs the audiovisual content to the content output apparatus 400 by which the passenger of the vehicle 1 is capable of viewing the audiovisual content. The audiovisual content may be a racing game or a movie, for example. The content reproduction apparatus 300 may be realized by, for example, a server apparatus on a cloud (external media solution), an information processing apparatus of the vehicle 1 (internal media solution), a mobile device used by the passenger of the vehicle 1, and the like. The passenger of the vehicle 1 is a driver or non-driver located on any one seat in the vehicle 1. Configuration examples of the external media solution and the internal media solution will be described later.

The content output apparatus 400 outputs (audio output and/or display) the audiovisual content to be reproduced by the content reproduction apparatus 300 so that the passenger of the vehicle 1 can view the audiovisual content. The content output apparatus 400 may be realized by one or more of displays installed in the vehicle 1 (e.g., a head-up display, a frunk display, a dashboard display, a rear display, a room mirror, a side-view mirror display, and the like), external displays, such as a large-size screen installed at a site of the charging equipment 200, mobile devices used by the passenger of the vehicle 1, head-mounted displays and headphones worn by the passenger of the vehicle 1, and the like.

The vibration apparatus 500 comes into contact with the vehicle 1 and vibrates the vehicle 1 from the outside, thereby making the passenger of the vehicle 1 feel vibration. Specifically, the vibration apparatus 500 is an installed-type vibration apparatus that comes into contact with a front wheel of the vehicle 1 and vibrates it from the outside or a self-propelled-type vibration apparatus that comes into contact with a jack-up point of the vehicle 1 and vibrates it from the outside. A specific configuration and an operation example of the vibration apparatus 500 will be described.

The vibration control apparatus 600 outputs a vibration signal to the vibration apparatus 500 and controls the vibration apparatus 500. In particular, the vibration control apparatus 600 controls the vibration apparatus 500 to vibrate the vehicle 1 while charging the vehicle 1 from the charging equipment 200 and reproducing the audiovisual content by the content reproduction apparatus 300.

### 3. Configuration Example of Media Solution

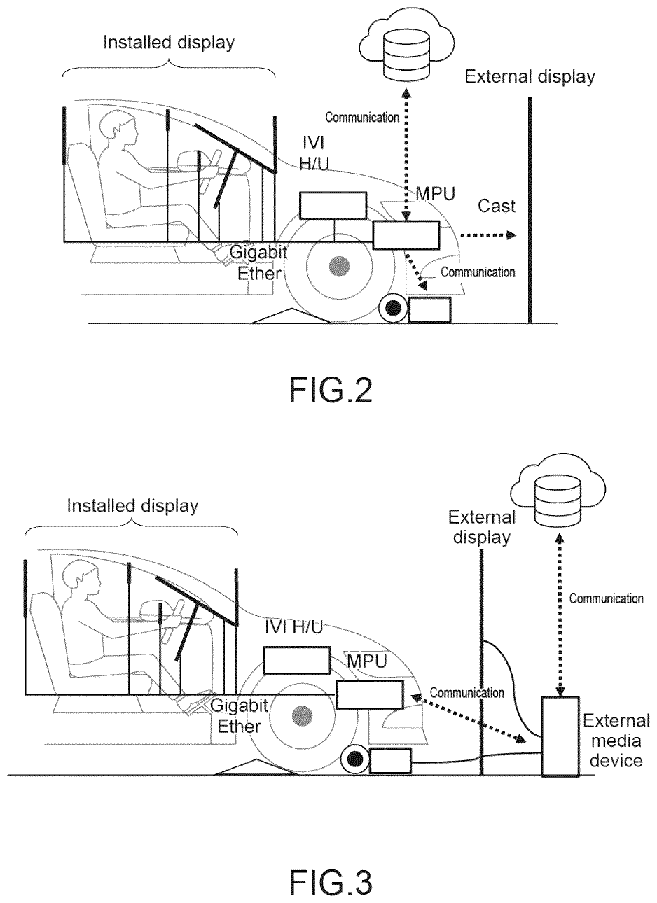

FIG. 2 shows a configuration example of the internal media solution.

The vibration control apparatus 600 and the content reproduction apparatus 300 may be located inside the vehicle 1. The vibration control apparatus 600 may generate the vibration signal or the vehicle body vibration apparatus 500 may generate the vibration signal. The vibration control apparatus 600 generating the vibration signal makes the communication with the vibration apparatus 500 simpler. As the content reproduction apparatus 300, an internal multi-media plug-in unit (MPU) of the vehicle 1 communicates with the cloud and generates a simulation in accordance with an operation input of a user from an internal in-vehicle infotainment head unit (IVI H/U). The video signal is output to an internal display and an external display as the content output apparatus 400. Video signals output to the internal display and the external display may be linked. Simultaneously, the internal MPU as the vibration control apparatus 600 generates a vibration signal, sends the vibration signal to the external vibration apparatus 500, and reproduces vibration.

FIG. 3 shows a configuration example of the external media solution.

The vibration control apparatus 600 and the content reproduction apparatus 300 may be located outside the vehicle 1. The vibration control apparatus 600 may generate the vibration signal or the vehicle body vibration apparatus 500 may generate the vibration signal. An external media device as the content reproduction apparatus 300 may perform vibration selection and content reproduction and the external vehicle body vibration apparatus 500 may generate the vibration signal. A simple configuration in which the external vehicle body vibration apparatus 500 itself serves as a media apparatus as the content reproduction apparatus 300 and performs vibration selection, content reproduction, and vibration signal generation may be employed. The content reproduction apparatus 300 as the external media device communicates with the cloud, and receives the operation input of the user from the internal IVI H/U through the internal MPU and sends it to the external media device by communication. The content reproduction apparatus 300 generates a simulation in accordance with that operation input of the user. The video signal is output to the external display as the content output apparatus 400 and output to the internal display by communication. Video signals output to the internal display and the external display may be linked. Simultaneously, the external media device as the vibration control apparatus 600 generates the vibration signal, sends it to the external vibration apparatus 500, and reproduces the vibration.

In the above-mentioned two configuration examples, possible connection methods between the apparatuses and between the clouds are the existing wired and wireless connection. As a wired protocol, it is sufficient to utilize Ethernet (registered trademark), HDMI (registered trademark), DP, USB, or the like. As a wireless protocol, it is sufficient to utilize 4G, 5G, satellite constellation, Wi-Fi (registered trademark), BT, IR, or UWB.

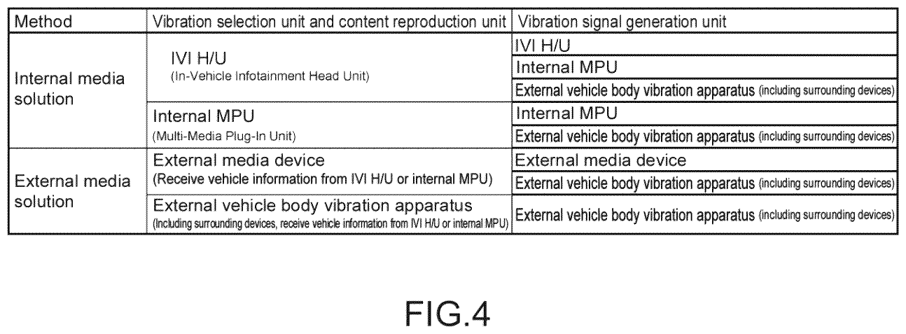

FIG. 4 is a table showing a configuration example of a system of the media solution.

A list in the figure is obtained, summarizing the functional configuration for realizing the internal media solution (FIG. 2) and the external media solution (FIG. 3).

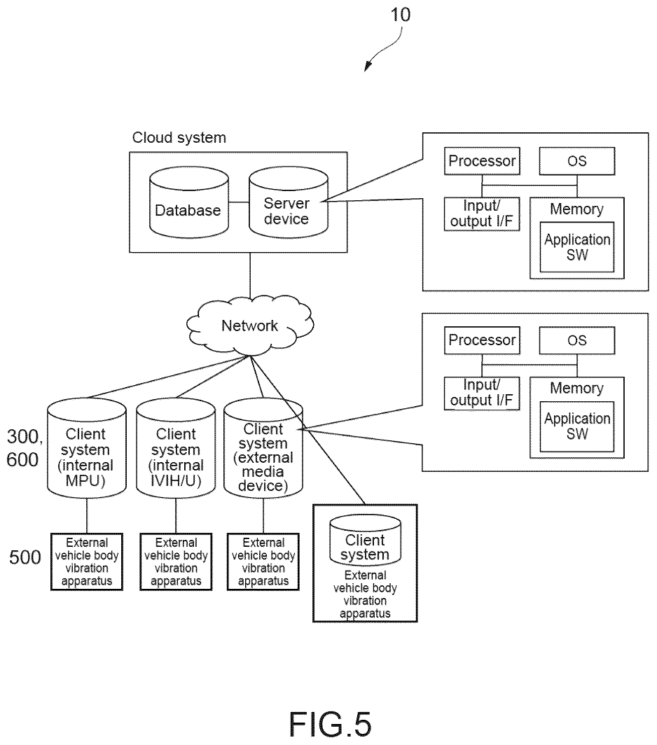

FIG. 5 shows a configuration example of a system of the media solution.

The figure is an example of a hardware configuration for realizing the internal media solution (FIG. 2) and the external media solution (FIG. 3). The control system 10 is cooperatively realized by hardware resources on on-site and the cloud executing software resources on on-site and the cloud.

### 4. Vibration Apparatus

The vehicle 1 has a structure in which a mass, vehicle body, is in contact with the ground via elastic members, such as tires and suspension. In order to vibrate this vehicle body by a simple and convenient method, it is necessary to add vibration in a place where the vibration can be added with as little energy as possible and without causing damage to the vehicle body (body scratches, tire wear). However, there is no vibration apparatus or vibration method that meets these requirements for an apparatus that vibrates the vehicle body from the outside.

In addition, the size and body frame structure of the vehicle 1, such as the vehicle width and wheelbase, differ depending on the vehicle type. In order to support a wide variety of vehicles 1 at a charging station, it is also necessary to absorb these differences of the vehicle 1.

In the present embodiment, the front wheel or the jack-up point is employed as the vibration point that comes into contact with the vehicle 1 and vibrates the vehicle 1. If the front wheel or the jack-up point is vibrated, it is possible to vibrate the vehicle 1 and make the passenger feel the vibration with as little energy as possible and without causing damage to the vehicle body (body scratches, tire wear). In the present embodiment, installed-type vibration apparatuses 510 and self-propelled-type vibration apparatuses 550 are exemplified as variations of the vibration apparatus 500.

First, the tires are points where the vehicle 1 is in contact with another object (typically, a road surface), and adding to vibration to them poses the least risk of causing a functional or visual damage. When the handbrake is applied, the rear wheels are locked, but the front wheels can rotate freely. In view of this, in the present embodiment, the installed-type vibration apparatuses 510 come into contact with and press parts of the front wheels, which are not in contact with the ground, inducing vibration to the vehicle 1.

Second, the jack-up points are the points where the equipment (jack) that lifts the vehicle 1 during repairs, etc., is attached, and the risk of causing a functional or visual damage to the vehicle 1 is lower than at other sites. The jack-up points are provided on the lower part of the vehicle body of the vehicle 1. There are usually six jack-up points in total: four points near the tires and two points on the front and rear sides near the center of the width of the vehicle bottom. The self-propelled-type vibration apparatus 550 crawls under the vehicle body of the vehicle 1 and presses the jack-up point upwards, inducing vibration to the vehicle 1.

### (1) Installed-Type Vibration Apparatus

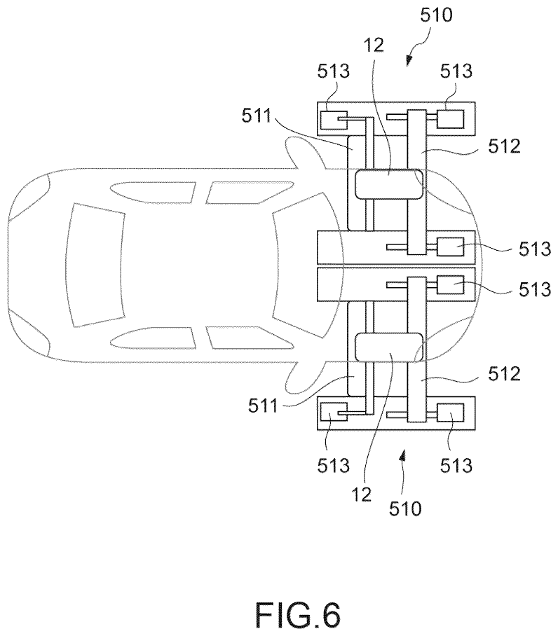

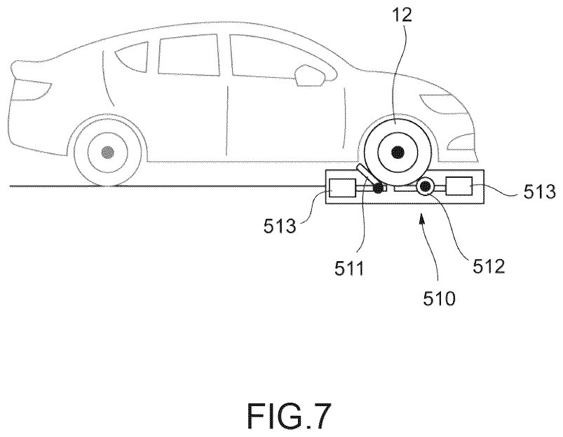

FIG. 6 is a top view showing the installed-type vibration apparatuses. FIG. 7 is a side view showing the installed-type vibration apparatuses.

The installed-type vibration apparatuses 510 rotate front wheels 12 while restricting the movement of the vehicle 1 due to the rotation of the front wheels 12 of the vehicle 1, thereby vibrating the vehicle 1. Each of the installed-type vibration apparatuses 510 includes a lock plate 511, a roll bar 512, and actuators 513.

The lock plate 511 has a structure in which a rear end 515 far from the roll bar 512 is lifted using a front end 514 close to the roll bar 512 as a support point. The lock plate 511 functions as a stopper that restricts the movement in the backward direction (single direction) of the front wheel 12 of the vehicle 1.

The roll bar 512 is horizontally movable in the forward direction and the backward direction of the vehicle 1 and is rotatable in clockwise and counter-clockwise directions. The roll bar 512 functions as a pushing unit that pushes the front wheel 12 with the movement in the backward direction restricted by the lock plate 511 in the backward direction, thereby rotating the front wheel 12 and vibrating the vehicle 1.

The actuators 513 are power sources that drive the roll bar 512 serving as a pushing unit. The actuators 513 may be, for example, a linear resonant actuator, a DC motor, a stepping motor, or the like. The linear resonant actuator is capable of determining a displacement position and a displacement amount depends on the number of pulses. The DC motor is incapable of determining the displacement position. The stepping motor is capable of determining the displacement amount on the basis of the number of pulses. It should be noted that the actuators 513 that drive the lock plate 511 are also additionally provided.

The two installed-type vibration apparatuses 510 are provided corresponding to the left and right front wheels 12. The installed-type vibration apparatuses 510 have a configuration in which the vehicle width (left-right width) is wider than the left and right front wheels 12. Moreover, the installed-type vibration apparatuses 510 may be movable in a vehicle width direction. Accordingly, they can support vehicles 1 with different front-wheel distances (e.g., about 2065 mm for large SUVs and about 1415 mm for one-box type station wagons). Moreover, the installed-type vibration apparatuses 510 are configured to support vehicles 1 with various weights (about 3360 kg for large sedans, about 600 kg or more for light cars).

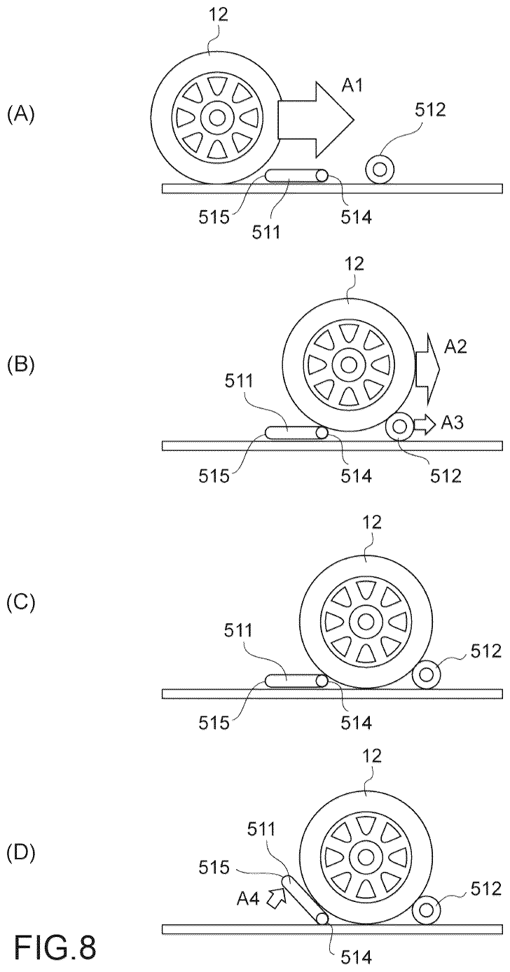

FIG. 8 schematically shows an operation in which the front wheel of the vehicle is fixed to the installed-type vibration apparatus.

(A) The front wheel 12 of the vehicle 1 rides up on the rear end 515 of the lock plate 511 and moves forward (arrow A1), such that the vehicle 1 is parked. (B) Next, the front wheel 12 of the vehicle 1 passes the upper surface of the lock plate 511 (arrow A2). When the front wheel 12 of the vehicle 1 comes into contact with the roll bar 512 to ride up on it, the front wheel 12 pushes the roll bar 512 in the forward direction. The roll bar 512 horizontally moves in the forward direction of the vehicle 1 (arrow A3). (C) Next, the front wheel 12 of the vehicle 1 descends from the front end 514 of the lock plate 511 and comes into contact with the ground, such that the vehicle 1 stops. (D) Next, the rear end 515 of the lock plate 511 is lifted using the front end 514 of the lock plate 511 as a support point (arrow A4), and the roll bar 512 and the lock plate 511 fix the front wheel 12, sandwiching the front wheel 12 in the front-rear direction. The driver applies the handbrake of the vehicle 1. When the handbrake is applied, the rear wheels are locked, but the front wheels 12 can rotate freely.

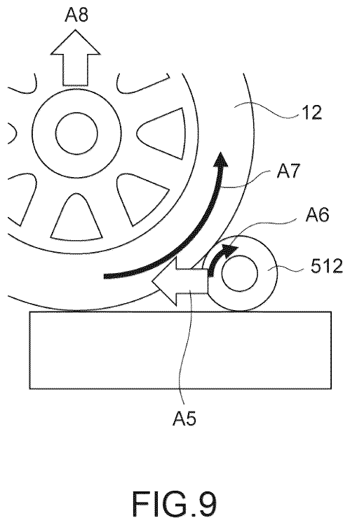

FIG. 9 schematically shows an operation in which the installed-type vibration apparatus vibrates the front wheel of the vehicle.

The roll bar 512 is driven by the actuators 513 to horizontally move in the backward direction and push the front wheel 12 in the backward direction (arrow A5). The front wheel 12 cannot move in the backward direction because the movement in the backward direction is restricted by the lock plate 511. Therefore, an elastic force accumulates in the suspension and the front wheel 12, and the front wheel 12 rotates in a direction to release this elastic force (arrow A6), and the roll bar 512 also rotates in an opposite direction (arrow A7). Accordingly, the vehicle body of the vehicle 1 moves in a direction to push up the front wheel 12 (arrow A8), and the vehicle 1 is vibrated without applying load to the front wheel 12.

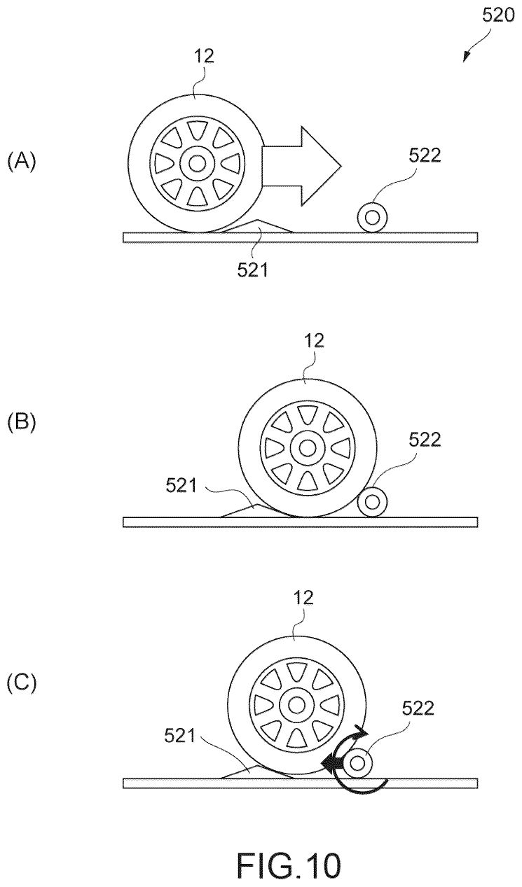

FIG. 10 schematically shows a first modified example of the installed-type vibration apparatus.

The installed-type vibration apparatuses 510 are not limited to the configuration of the installed-type vibration apparatuses 510 (FIGS. 3 to 6) as long as it can rotate the front wheel 12 while restricting the movement of the vehicle 1 due to the rotation of the front wheel 12 of the vehicle 1, thereby vibrating the vehicle 1. The installed-type vibration apparatuses 510 only needs to include a stopper that restricts the movement in the backward direction (single direction) of the front wheel 12 of the vehicle 1, a pushing unit that pushes the front wheel 12 whose movement in the backward direction is restricted, in the backward direction, thereby rotating the front wheel 12 and vibrating the vehicle 1, and an actuator that drives the roll bar 512 serving as the pushing unit. Hereinafter, a variation of the installed-type vibration apparatus 510 will be described.

The installed-type vibration apparatus 520 includes a fixed-type wheel chock 521 in the shape of a mountain, a roll bar 522 (configuration similar to the roll bar 512), and a power source (not shown). (A) The front wheel 12 of the vehicle 1 rides up on the fixed-type wheel chock 521 and moves forward, such that the vehicle 1 is parked. (B) Next, the front wheel 12 of the vehicle 1 moves forward in a descending direction from the top of the fixed-type wheel chock 521. When the front wheel 12 of the vehicle 1 comes into contact with the roll bar 522 to ride up on it, the front wheel 12 pushes the roll bar 522 in the forward direction. (C) The roll bar 522 is driven by the power source to horizontally move in the backward direction and push the front wheel 12 in the backward direction. The front wheel 12 and the roll bar 522 rotate and the vehicle 1 is vibrated.

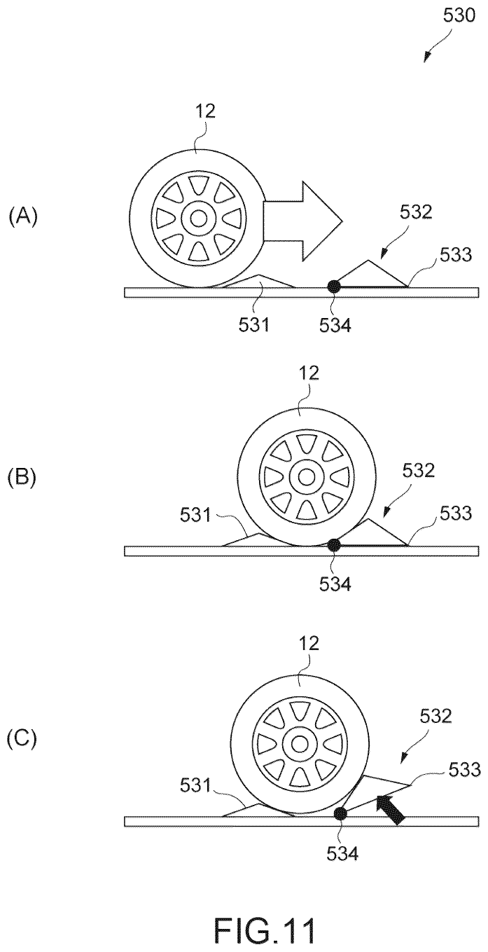

FIG. 11 schematically shows a second modified example of the installed-type vibration apparatus.

An installed-type vibration apparatus 530 includes a fixed-type wheel chock 531 in the shape of a mountain (configuration similar to the fixed-type wheel chock 521), a movable-type wheel chock 532 in the shape of a mountain, and a power source (not shown). The movable-type wheel chock 532 has a structure in which a front end 533 far from the fixed-type wheel chock 531 is lifted using a rear end 534 close to the fixed-type wheel chock 531 as a support point. (A) The front wheel 12 of the vehicle 1 rides up on the fixed-type wheel chock 531 and moves forward, such that the vehicle 1 is parked. (B) Next, the front wheel 12 of the vehicle 1 moves forward in a descending direction from the top of the fixed-type wheel chock 531. The front wheel 12 of the vehicle 1 comes into contact with the movable-type wheel chock 532 to ride up on it. (C) The movable-type wheel chock 532 is driven by the power source, the front end 533 is lifted using the rear end 534 as a support point, pushes the front wheel 12, and the vehicle 1 is vibrated.

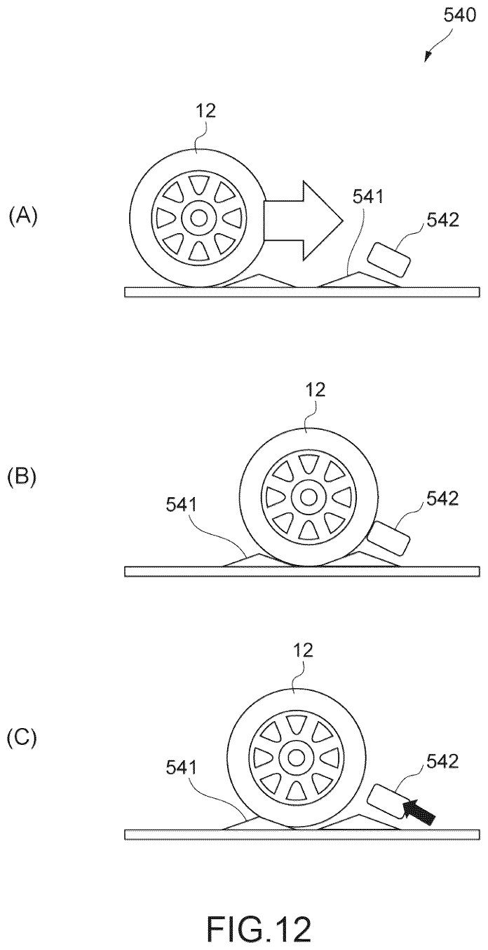

FIG. 12 schematically shows a third modified example of the installed-type vibration apparatus.

An installed-type vibration apparatus 540 includes a recessed-type wheel chock 541, a push pin 542, and a power source (not shown). (A) The front wheel 12 of the vehicle 1 rides up on the recessed-type wheel chock 541 and moves forward, and the vehicle 1 is parked. (B) Next, the front wheel 12 of the vehicle 1 fits in the recessed-type wheel chock 541, such that the movement in the forward direction and the backward direction is restricted. (C) The push pin 542 is driven by the power source, pushes the front wheel 12, the vehicle 1 is vibrated. It should be noted that as a modified example, a recess may be provided in the ground instead of installing the recessed-type wheel chock 541 on the ground.

In yet another modified example, each of the installed-type vibration apparatuses 510, 520, 530, and 540 may restrict the movement of the front wheel 12 in the forward direction (single direction) and push the front wheel 12 in the forward direction, thereby vibrating the vehicle 1, in contrast to the description so far.

### (2) Self-Propelled-Type Vibration Apparatus

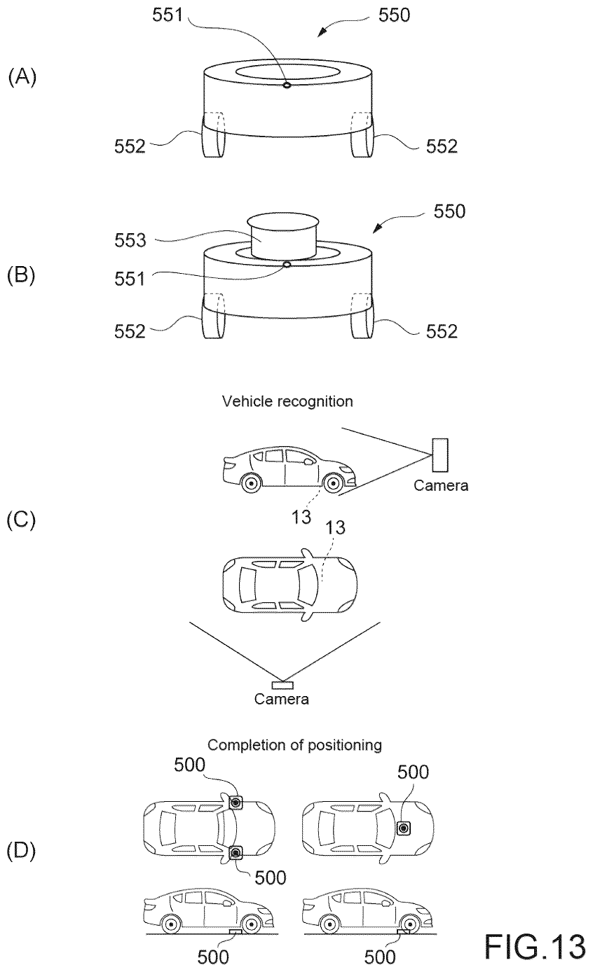

FIG. 13 schematically shows the self-propelled-type vibration apparatus.

As shown in (A), the self-propelled-type vibration apparatus 550 includes a camera 551 (image sensor), wheels 552 (self-propelled mechanism), and an actuator 553.

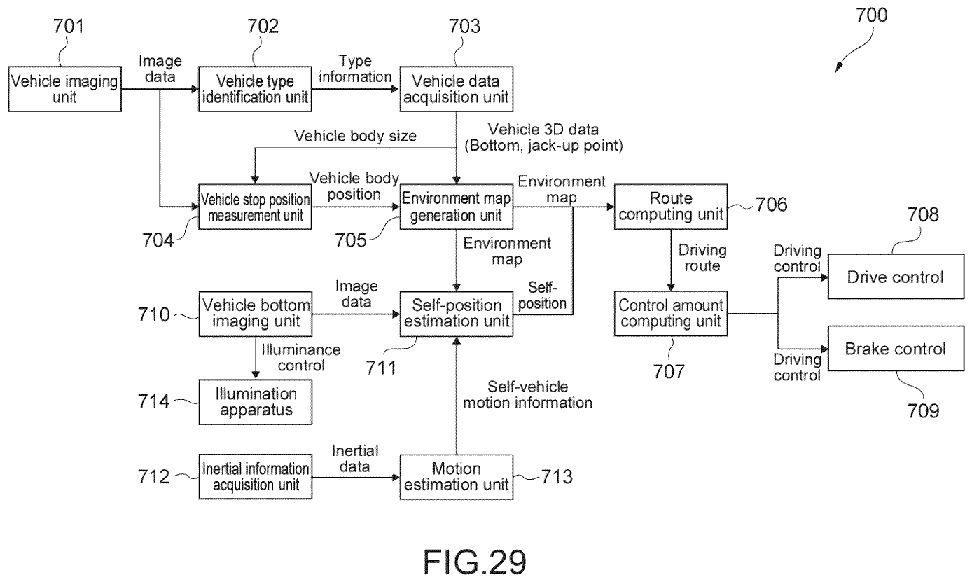

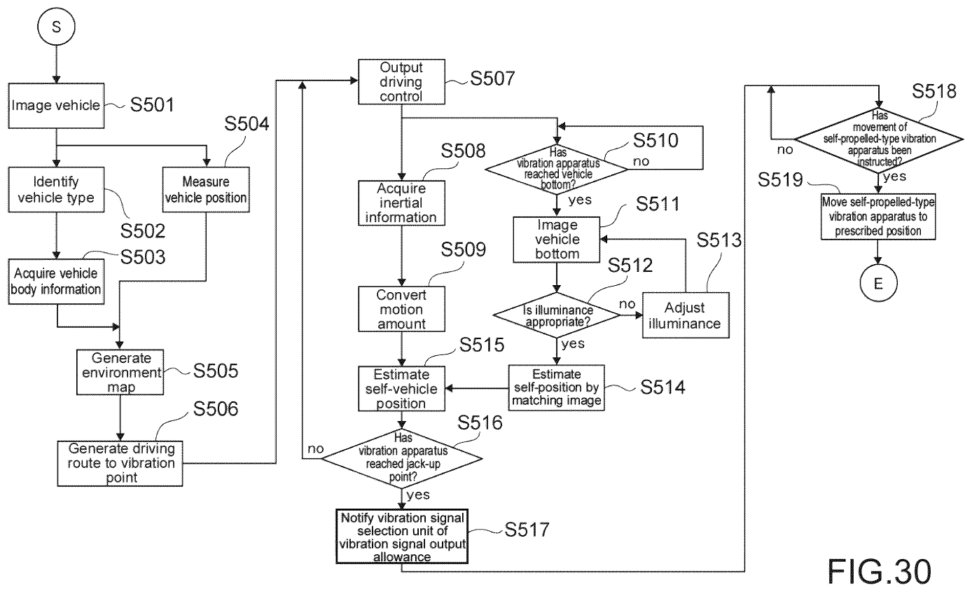

In order to detect the jack-up point 13 (vibration point), the self-propelled-type vibration apparatus 550 moves by its own power through the wheels 552 under the vehicle 1. As shown in (C), it is sufficient that the self-propelled-type vibration apparatus 550 only needs to be positioned on the basis of image data of the camera. Details of the self-propelled movement processing will be described later with reference to FIGS. 29 and 30.

The vibration point is detected on the basis of a sensing result of the camera 551. The vibration point is at least one jack-up point 13 of the vehicle 1. In general, jack-up points do not have common marks or the like, and the position of the jack-up point 13 differs depending on the vehicle type. Therefore, the jack-up point 13 is recognized from a sensing result of the camera 551. The recognition processing will be described later in detail with reference to FIGS. 29 and 30.

The self-propelled-type vibration apparatus 550 is moved by its own power through the wheels 552 to a vibration position for vibrating the detected jack-up point 13 (vibration point). By the self-propulsion of the wheels 552, the self-propelled-type vibration apparatus 550 crawls under the jack-up point 13 (vibration point) of the vehicle 1. As shown in (D), the positioning of the self-propelled-type vibration apparatus 550 is completed. The position of the self-propelled-type vibration apparatus 550 differs in accordance with the position of the jack-up point 13 for each vehicle 1. The position of the self-propelled-type vibration apparatus 550 is a position near the left and right front wheels, a center position between the left and right front wheels, or the like.

As shown in (B), the self-propelled-type vibration apparatus 550 controls the actuator 553 so that the self-propelled-type vibration apparatus 550 vibrates the jack-up point 13 (vibration point), from the vibration position (under the vehicle body) to which the self-propelled-type vibration apparatus 550 has been moved through the wheels 552. The actuator 553 presses the jack-up point 13 upwards, inducing vibration to the vehicle 1, as if an active suspension were externally attached.

### (3) Modified Example

The installed-type vibration apparatus 510 or the like that vibrates the front wheel 12 as an installed type and the self-propelled-type vibration apparatus 550 that vibrates the jack-up point 13 as a self-propelled type have been described. It may be replaced by a vibration apparatus that vibrates the front wheel 12 in a self-propelled-manner. That is, a self-propelled-type vibration apparatus (not shown) may detect the vibration point (front wheel) from the sensing result of the image sensor, moves to the vibration position for vibrating the detected vibration point (front wheel) by its own power, and vibrates the vibration point (front wheel).

Various methods are conceivable as how to push the vehicle 1. If the tires are pushed simply in the same cycle, they may be in opposite phase to the vibration of the vehicle body, and an excessive force is generated. Therefore, it is useful to control the vibration of the vehicle 1 by monitoring a pressure generated at the contact surface and making a feedback.

### 5. Control System in Which Installed-Type Vibration Apparatus Is Utilized

### (1) Control System and Operation

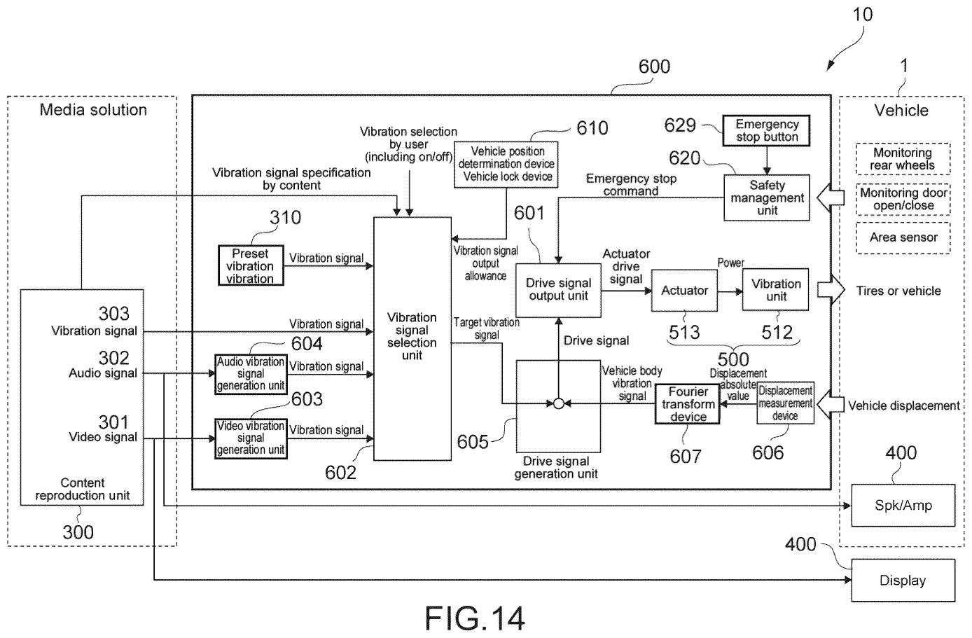

FIG. 14 shows an example of a control system configuration in which the installed-type vibration apparatus is utilized.

The example in the figure shows a configuration example in which the vibration control apparatus 600 that is a control system and the vibration apparatus 500 that is a power system are integrated.

In the vibration control apparatus 600, a vehicle position determination device 610 sends a vibration signal output allowance notification to a vibration signal selection unit 602. A video vibration signal generation unit 603 receives a video signal 301 of the audiovisual content, generates a video vibration signal from the video signal 301, and sends the video vibration signal to the vibration signal selection unit 602. An audio vibration signal generation unit 604 receives an audio signal 302 of the audiovisual content, generates an audio vibration signal from the audio signal 302, and sends the audio vibration signal to the vibration signal selection unit 602.

The vibration signal selection unit 602 reads out whether the user has set the vibration on or off. The vibration signal selection unit 602 receives the vibration signal output allowance notification from the vehicle position determination device 610, receives a specific vibration signal 303 output from the audiovisual content, receives the video vibration signal from the video vibration signal generation unit 603, and receives the audio vibration signal from the audio vibration signal generation unit 604. The vibration signal selection unit 602 selects any one of the specific vibration signal 303, the video vibration signal, the audio vibration signal, or a preset vibration signal 310 as a target vibration signal and sends the target vibration signal to a drive signal generation unit 605.

A displacement measurement device 606 calculates a displacement amount of the vehicle 1 and inputs the displacement amount to a Fourier transform device 607. The Fourier transform device 607 Fourier-transforms the displacement amount input from the displacement measurement device 606, generates a vehicle body vibration signal, and sends to the vehicle body vibration signal to the drive signal generation unit 605. The drive signal generation unit 605 receives the target vibration signal from the vibration signal selection unit 602 and receives the vehicle body vibration signal from the Fourier transform device 607. The drive signal generation unit 605 generates a drive signal by using the target vibration signal and the vehicle body vibration signal and sends the drive signal to a drive signal output unit 601.

The drive signal output unit 601 receives the drive signal from the drive signal generation unit, converts the drive signal to an actuator drive signal, and outputs the actuator drive signal to the actuators 513. In the vibration apparatus 500, the actuators 513 are driven in accordance with an actuator drive signal 323 to displace the roll bar 512 by applying power to the roll bar 512, which is a vibration unit, vibrating the vehicle 1. A safety management unit 620 outputs an emergency stop command to the drive signal output unit 601 when an abnormality, such as an operation of the emergency stop button 629, is detected. When the drive signal output unit 601 receives an emergency stop command from the safety management unit 620, the drive signal output unit 601 stops outputting the actuator drive signal to the actuators 513.

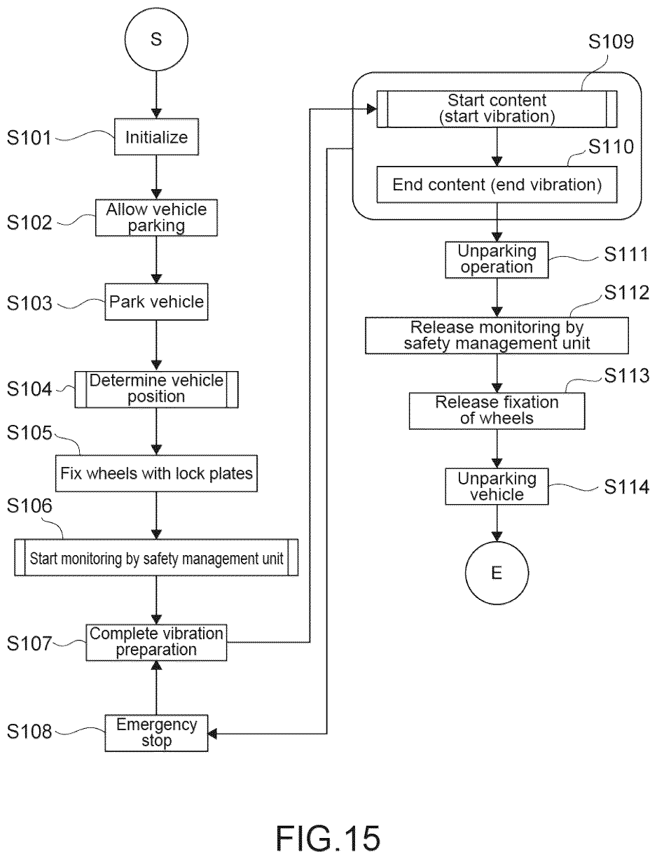

FIG. 15 shows an operation flow of the control system in which the installed-type vibration apparatus is utilized.

The vibration control apparatus 600 performs initialization in a state in which the vehicle 1 is not parked in the parking area where the vibration apparatus 500 is installed (Step S101), such that the vehicle 1 is allowed to be parked (Step S102). When the vehicle position determination device 610 detects that the vehicle 1 has been parked (Step S103), a stop position of the vehicle 1 with respect to the vibration apparatus 500 is determined (Step S104). In a case where the stop position of the vehicle 1 is OK, the vehicle position determination device 610 fixes the front wheels 12 of the vehicle 1 with the lock plates 511 of the vibration apparatus 500 (Step S105). On the other hand, the safety management unit 620 starts safety management (Step S106). The vehicle position determination device 610 notifies the vibration signal selection unit 602 of the vibration signal output allowance, such that the vibration preparation is completed (Step S107).

The content reproduction apparatus 300 starts reproducing the audiovisual content and the passenger of the vehicle 1 views audiovisual content output by the content output apparatus 400. The vibration control apparatus 600 outputs a drive signal to the vibration apparatus 500 and starts vibrating the vehicle 1 (Step S109). When the safety management unit 620 detects an abnormality, the vibration control apparatus 600 stops outputting the drive signal to the vibration apparatus 500 and emergently stops vibrating the vehicle 1 (Step S108). When the content reproduction apparatus 300 terminates the reproduction of the audiovisual content, the vibration control apparatus 600 stops outputting the drive signal to the vibration apparatus 500 and terminates the vibration to the vehicle 1 (Step S110).

When an operation of unparking the vehicle 1 is started (Step S111), the safety management unit 620 terminates the safety management (Step S112). The vehicle position determination device 610 releases the fixation of the front wheels 12 by the lock plates 511 of the vibration apparatus 500 (Step S113). When the vehicle 1 moves out of the parking area, the vibration control apparatus 600 terminates the processing (Step S114).

### (2) Vehicle Position Determination Device

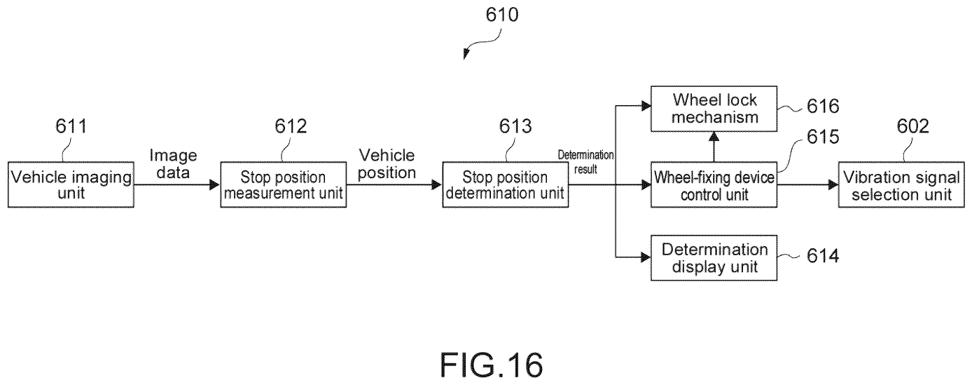

FIG. 16 shows a functional configuration of the vehicle position determination device.

The vehicle position determination device 610 includes a vehicle imaging unit 611, a stop position measurement unit 612, a stop position determination unit 613, a determination display unit 614, a wheel-fixing device control unit 615, and a wheel lock mechanism 616. The wheel lock mechanism 616 includes the lock plates 511 and the actuators 513 of the vibration apparatus 500.

In the vehicle position determination device 610, the vehicle imaging unit 611 sends image data obtained by imaging the vehicle 1 to the stop position measurement unit 612. The stop position measurement unit 612 receives the image data from the vehicle imaging unit 611, measures the position of the vehicle 1 on the basis of the image data, and sends the position information of the vehicle 1 to the stop position determination unit 613. The stop position determination unit 613 receives the position information of the vehicle 1 from the stop position measurement unit 612 and determines whether or not the stop position of the vehicle 1 is in an allowable range. The stop position determination unit 613 sends the result of determination to the determination display unit 614 and the wheel-fixing device control unit 615. The determination display unit 614 receives the result of determination from the stop position determination unit 613 and displays the result of determination on the basis of information related to the stop position of the vehicle 1. The wheel-fixing device control unit 615 receives the result of determination from the stop position determination unit 613. Then, in a case where the stop position of the vehicle 1 is in the allowable range (OK), the wheel-fixing device control unit 615 lifts the lock plates 511 as the wheel lock mechanism 616 and fixes the front wheels 12 of the vehicle 1. The vehicle position determination device 610 notifies the vibration signal selection unit 602 of the vibration signal output allowance.

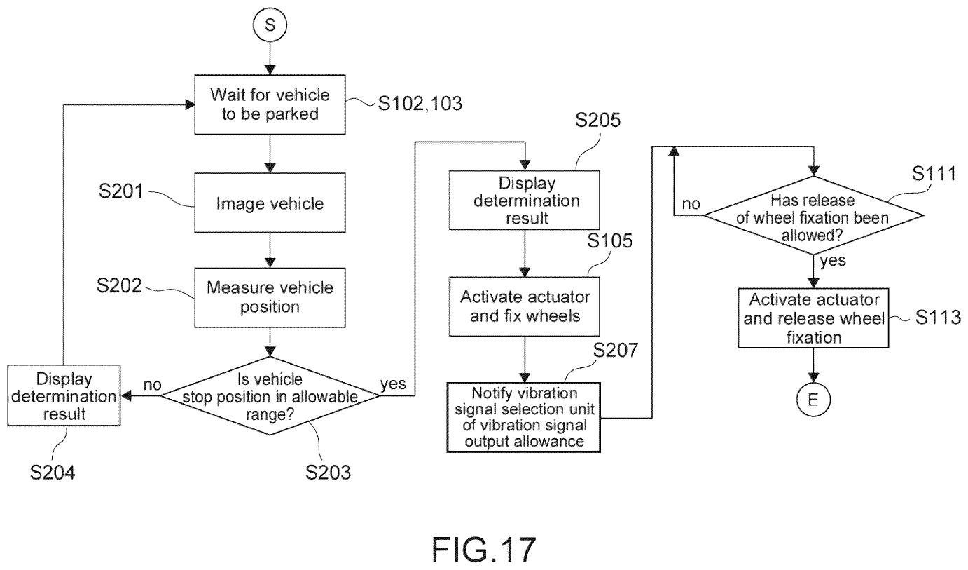

FIG. 17 shows the operation flow (Step S104) of the vehicle position determination device.

The vehicle 1 is allowed to be parked (Step S102). When the vehicle 1 is parked (Step S103), the vehicle imaging unit 611 images the vehicle 1 (Step S201). The vehicle imaging unit 611 only needs to include a camera capable of imaging a visible light image, an IR image, a depth image, or the like. The stop position measurement unit 612 measures the position of the vehicle 1 on the basis of the image data captured by the vehicle imaging unit 611 (Step S202). The position of the vehicle 1 may be, for example, a relative position of the front wheel 12 of the vehicle 1 with respect to the installed-type vibration apparatus 500. The stop position determination unit 613 determines whether or not the stop position of the vehicle 1 is in the allowable range (Step S203). For example, the stop position determination unit 613 only needs to perform the determination on the basis of, for example, a contact amount of the front wheels 12 of the vehicle 1 with respect to the installed-type vibration apparatus 500 and a tilt amount between the axis of the vibration apparatus 500 and the axis of each front wheel 12.

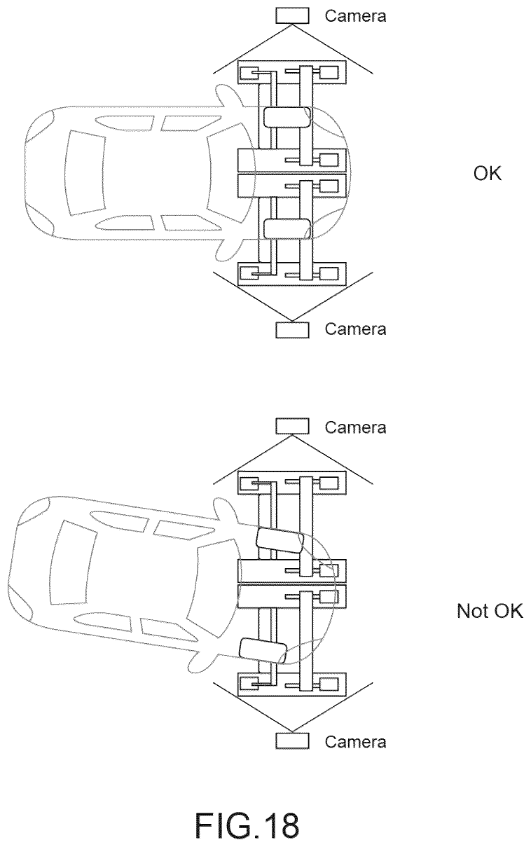

FIG. 18 schematically shows an example of the stop position.

When the stop position determination unit 613 determines that the stop position of the vehicle 1 is out of the allowable range (NG) (no in Step S203), the determination display unit 614 displays information for prompting the user to change the stop position of the vehicle 1 (Step S204). On the other hand, in a case where the stop position determination unit 613 determines that the stop position of the vehicle 1 is in the allowable range (OK) (yes in Step S203), the determination display unit 614 displays information indicating that the stop position of the vehicle 1 is in the allowable range (OK) (Step S205). The determination display unit 614 may display a top view as shown in the figure. The determination display unit 614 only needs to display it on, for example, a head-up display of the vehicle 1, a display such as LED installed in the vehicle 1, a display apparatus installed at a site of the charging equipment 200, or a mobile device used by the passenger of the vehicle 1.

In a case where the stop position of the vehicle 1 is in the allowable range (OK) (yes in Step S203), the wheel-fixing device control unit 615 activates the actuators, lifts the lock plates 511 as the wheel lock mechanism 616, and fixes the front wheels 12 of the vehicle 1 (Step S105). The vehicle position determination device 610 notifies the vibration signal selection unit 602 of the vibration signal output allowance (Step S207), and causes the safety management unit 620 to starts management (Step S106).

Then, when the operation of unparking the vehicle 1 is started (yes in Step S111), the wheel fixation is allowed to be released (Step S208). The vehicle position determination device 610 releases the fixation of the front wheel 12 by the lock plates 511 of the vibration apparatus 500 (Step S113).

### (3) Safety Management Unit

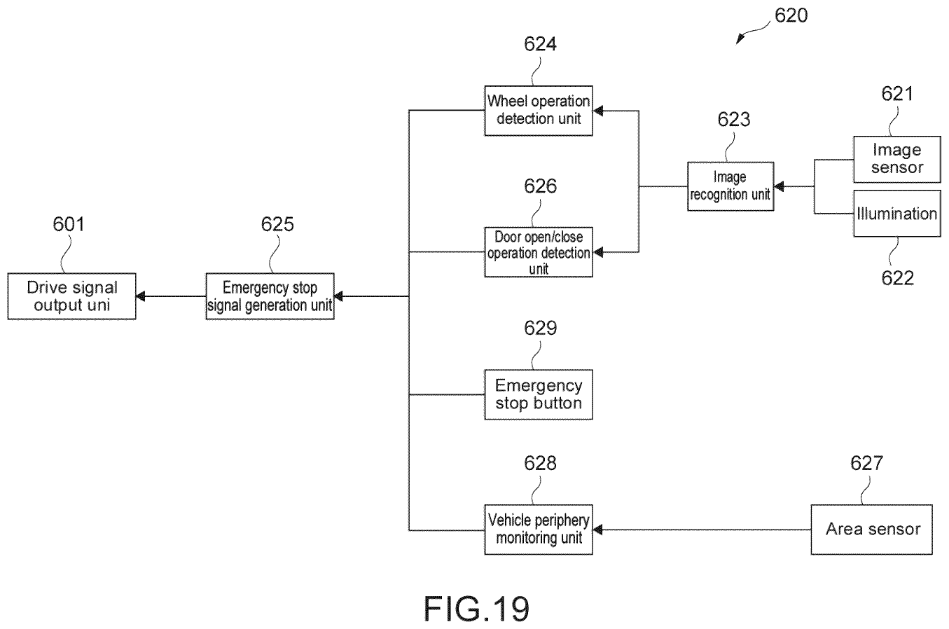

FIG. 19 shows a functional configuration of the safety management unit.

The safety management unit 620 includes an image sensor 621, an illumination 622, an image recognition unit 623, a wheel operation detection unit 624, an emergency stop signal generation unit 625, a door open/close operation detection unit 626, an area sensor 627, a vehicle periphery monitoring unit 628, and an emergency stop button 629.

In the safety management unit 620, the image sensor 621 obtains an image by using the illumination 622, generates image data, and sends the image data to the image recognition unit 623. The image recognition unit 623 receives the image data from the image sensor 621, identifies a vehicle axis position of the rear wheels (center position of the rear wheels) and door open/close by image recognition and saves them as a history image. In a case where the wheel operation detection unit 624 detects that the vehicle axis position of the rear wheels has changed beyond a threshold (i.e., the rear wheels have rotated) on the basis of the history image saved by the image recognition unit 623, the wheel operation detection unit 624 notifies the emergency stop signal generation unit 625 of it. In a case where the door open/close operation detection unit 626 detects that the door has been opened on the basis of the history image saved by the image recognition unit 623, the door open/close operation detection unit 626 notifies the emergency stop signal generation unit 625 of it. The area sensor 627 sends detected information in a predetermined area to the vehicle periphery monitoring unit 628. The vehicle periphery monitoring unit 628 receives the detected information of the area sensor 627. Then, in a case where the vehicle periphery monitoring unit 628 detects an intruder (e.g., pedestrian) in the parking area on the basis of the detected information, the vehicle periphery monitoring unit 628 notifies the emergency stop signal generation unit 625 of it. In a case where the emergency stop signal generation unit 625 receives these notifications and in a case where the emergency stop button 629 is pressed, the emergency stop signal generation unit 625 sends an emergency stop signal to the drive signal output unit 601.

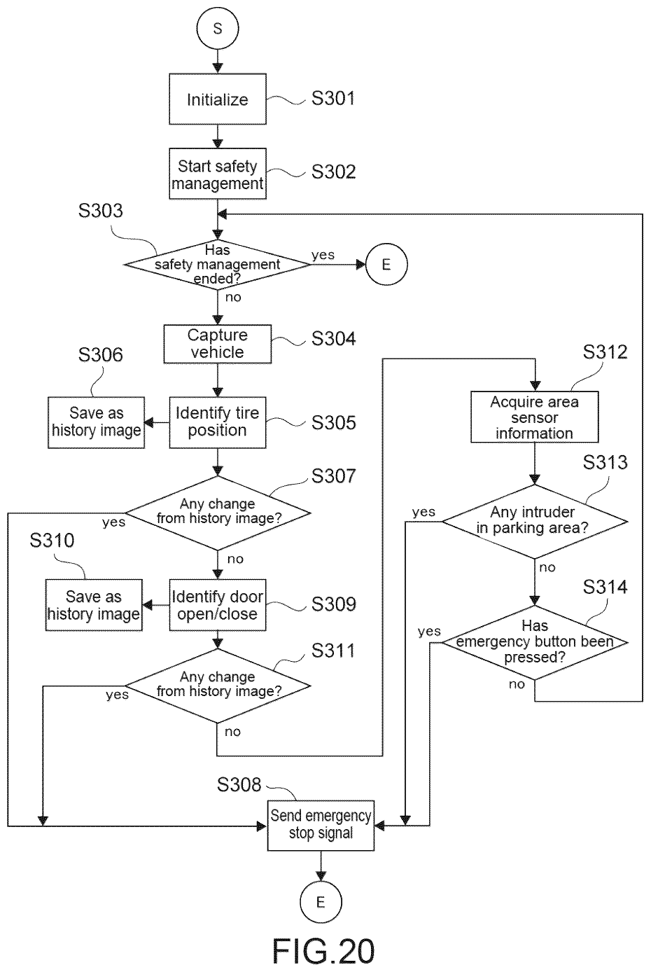

FIG. 20 shows the operation flow (Step S106) of the safety management unit.

The safety management unit 620 performs initialization (Step S301) and starts safety management (Step S302). During the safety management (no in Step S303), the image sensor 621 images the vehicle body by using the illumination 622 (in particular, in a case where illuminance is insufficient, for example, in an underground parking area) (Step S304). For example, the illumination 622 is a visible light illumination and the image sensor 621 is a visible light image sensor and generates a visible light image. Alternatively, the illumination 622 is an IR illumination and the image sensor 621 is an IR image sensor and generates an IR image. The image sensor 621 may be an event-based vision sensor (EVS). The EVS detects a luminance change of each pixel in a non-synchronized manner, and outputs only data that has changed in combination with information about coordinates and time.

Since the positions of the front wheels are fixed by the vibration apparatus 500, the positions of the rear wheels move back and forth depending on the length of the wheelbase of the stopped vehicle 1. The length of the wheelbase is, for example, approximately 1805 mm to 3827 mm, and is about 2653 mm in average. In order to monitor the rear wheels with various lengths of the wheelbase, it is advantageous to increase the angle of view of the image sensor 621. It should be noted that in a case where no rear wheels are detected in the monitoring area, the vibration apparatus 500 does not operate.

The image recognition unit 623 recognizes the captured image, identifies the vehicle axis position of the rear wheels (center position of the rear wheels) (Step S305), and saves it as a history image (Step S306). The wheel operation detection unit 624 determines whether a change in positions of the rear wheels in the latest image has exceeded the threshold (i.e., the rear wheels have rotated) as compared to the history image (Step S307). It is sufficient that this threshold is an upper limit value of an amount by which the vehicle axis position of the rear wheels changes when vibrating the vehicle 1. In a case where the vehicle axis position of the rear wheels has changed beyond the threshold (i.e., the rear wheels have rotated) (yes in Step S307), the emergency stop signal generation unit 625 sends an emergency stop signal to the drive signal output unit 601 (Step S308).

In addition, the image recognition unit 623 recognizes the captured image, identifies the open/close of the door (Step S309), and saves it as a history image (Step S310). The door open/close operation detection unit 626 determines whether the open/close state of the door in the latest image has changed (the door has been opened) as compared to the history image (Step S311). It should be noted that the door open/close operation detection unit 626 may monitor the open/close of the door by a proximity sensor or a distance measure. In a case where the door has been opened (yes in Step S311), the emergency stop signal generation unit 625 sends an emergency stop signal to the drive signal output unit 601 (Step S308).

On the other hand, the area sensor 627 is an infrared sensor that performs object detection in a predetermined area. The vehicle periphery monitoring unit 628 obtains detected information of the area sensor 627 (Step S312). The vehicle periphery monitoring unit 628 determines whether there is an intruder (e.g., pedestrian) in the parking area on the basis of the detected information of the area sensor 627 (Step S313). In a case where there is an intruder (yes in Step S313), the emergency stop signal generation unit 625 sends an emergency stop signal to the drive signal output unit 601 (Step S308).

On the other hand, in a case where the emergency stop button 629 is pressed (yes in Step S314), the emergency stop signal generation unit 625 sends an emergency stop signal to the drive signal output unit 601 (Step S308). Accordingly, it is possible to secure safety even at a charging station or parking area where the passenger can get in and out of the vehicle 1 or a pedestrian can be present.

### (4) Vibration Signal Selection Unit

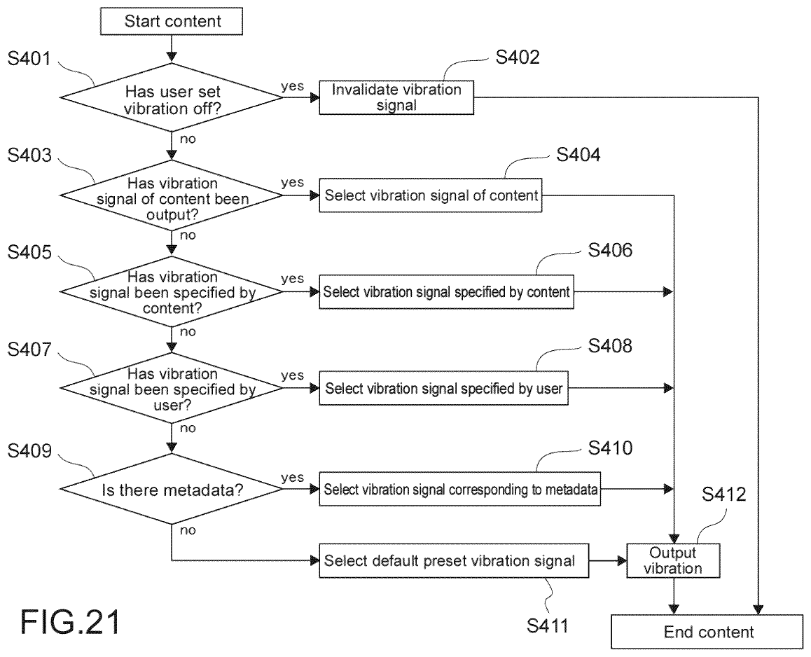

FIG. 21 shows the operation flow (Step S109) of the vibration signal selection unit.

The vibration signal selection unit 602 selects a vibration signal in accordance with audiovisual content reproduced by the content reproduction apparatus 300. An example thereof will be described.

The vibration signal selection unit 602 determines whether the user has set the vibration on or off (Step S401). In a case where the user has set the vibration off (yes in Step S401), the vibration signal selection unit 602 invalidates the vibration signal (Step S402).

On the other hand, in a case where the user has set on the vibration (no in Step S401), the vibration signal selection unit 602 determines whether the specific vibration signal 303 is involved in the audiovisual content (or determines whether the audiovisual content and the specific vibration signal 303 are included in single content data) (Step S403). The vibration signal selection unit 602 outputs the specific vibration signal 303 in addition to the video signal 301 and the audio signal 302 depending on the audiovisual content. The specific vibration signal 303 is a vibration signal specific to the audiovisual content created as a part of the audiovisual content together with the video signal 301 and the audio signal 302. In a case where the specific vibration signal 303 is involved in the audiovisual content (or in a case where the audiovisual content and the specific vibration signal 303 are included in single content data) (yes in Step S403), the vibration signal selection unit 602 selects the vibration signal 303 specific to the audiovisual content (Step S404).

On the other hand, in a case where the specific vibration signal 303 is not involved in the audiovisual content (or in a case where the audiovisual content and the specific vibration signal 303 are not included in single content data) (no in Step S403), the vibration signal selection unit 602 determines whether the vibration signal has been specified by the audiovisual content (Step S405). In a case where the vibration signal has been specified by the audiovisual content (yes in Step S405), the vibration signal selection unit 602 selects a vibration signal specified by the audiovisual content (Step S406). The specified vibration signal includes an audio vibration signal that the audio vibration signal generation unit 604 generates from the audio signal 302, a video vibration signal that the video vibration signal generation unit 603 generates from the video signal 301, and a preset vibration signal 310 not depending on the audiovisual content.

The audio vibration signal generation unit 604 generates an audio vibration signal from the audio signal 302 by, for example, the method described in Patent Literature 1. Specifically, the audio vibration signal generation unit 604 calculates spectrum of the audio signal 302 at each time by a generally-used method, such as a fast Fourier transform (FFT) arithmetic operation for each predetermined cycle. The audio vibration signal generation unit 604 calculates a change per unit time of the sum over the entire frequency band of the spectrum, thereby calculating a time derivative of the spectrum and obtaining a waveform of the time derivative. The audio vibration signal generation unit 604 compares a peak of the waveform of the time derivative and a derivative value with a preset threshold and extracts a waveform with a peak beyond the threshold as a beat component. The beat component extracted as a result includes information about a beat timing and beat intensity at that time. The audio vibration signal generation unit 604 applies an envelope to the extracted waveform to generate a waveform that rises at the beat timing and decays at a slower rate than the rise rate (beat waveform). The audio vibration signal generation unit 604 generates an audio vibration signal with beat components of the audio signal 302 emphasized.

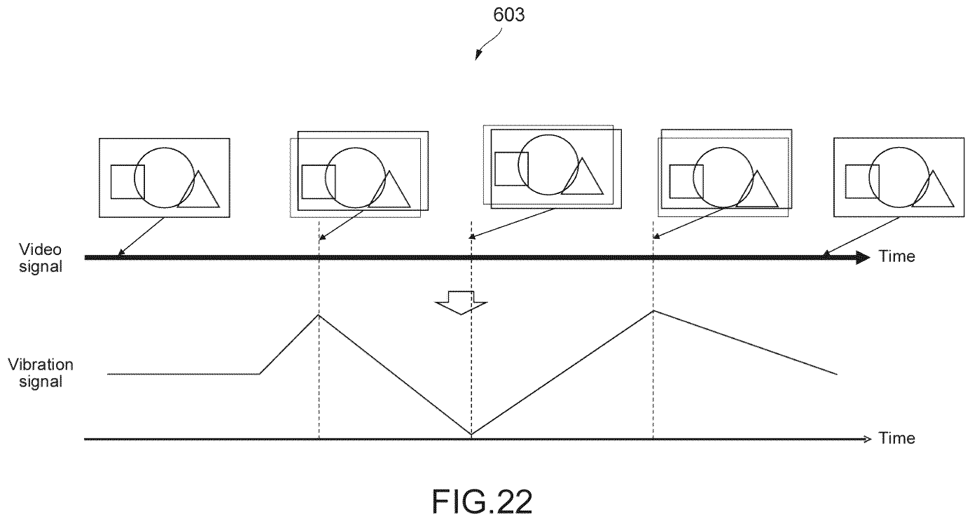

FIG. 22 schematically shows an operation of the video vibration signal generation unit.

The video vibration signal generation unit 603 detects a frame motion of the video signal 301 and converts the frame motion to a video vibration signal, thereby generating the video vibration signal. For example, the video vibration signal generation unit 603 generates a video vibration signal with a vibration amount depending on the amount of frame motion per unit time.

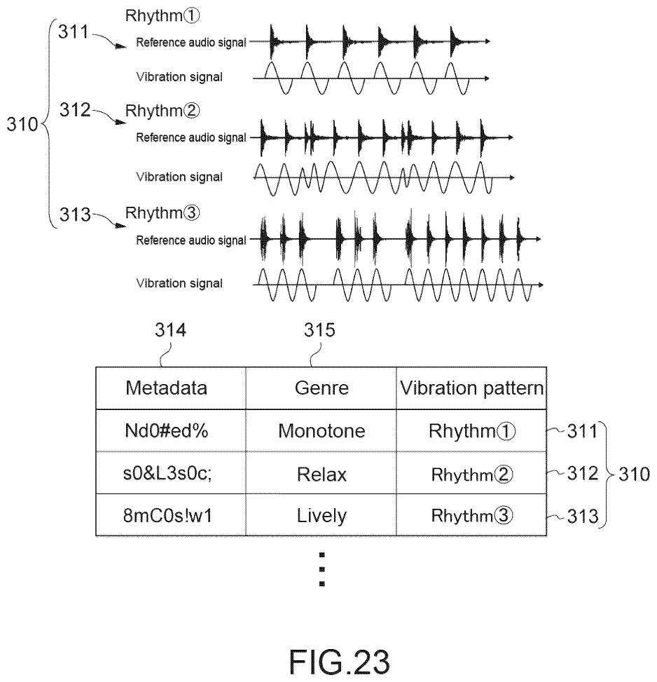

FIG. 23 schematically shows the preset vibration signal.

A plurality of different preset vibration signals 311, 312, and 313 is prepared in advance as the preset vibration signal 310. For example, the preset vibration signal 311 is a monotonous constant rhythm, the preset vibration signal 312 is a relaxing 4-beat rhythm, and the preset vibration signal 313 is a lively 3-3-7-beat rhythm. Metadata 314 and a genre 315 are associated with each of the preset vibration signals 311, 312, and 313. Moreover, any one preset vibration signal 310 is set as a default preset vibration signal. In a case where the preset vibration signal 310 has been specified, any one of the preset vibration signals 311, 312, and 313 may be specified. Alternatively, in case where any one of the preset vibration signals 311, 312, and 313 has not been specified, the vibration signal selection unit 602 may select any preset vibration signal 310. In a case where any one of the preset vibration signals 311, 312, and 313 has not been specified, it is sufficient to select, for example, the preset vibration signal 310 with the genre 315 corresponding to the genre of the audiovisual content.

In this manner, the vibration signal corresponding to a reference audio signal with each genre may be used as the preset vibration signal with each genre. Otherwise, the preset vibration signal may retain the vibration signal corresponding to each genre in advance. A vibration signal may be generated by using a plurality of pieces of content corresponding to each genre and a representative vibration signal may be used as a preset vibration signal corresponding to that genre. For example, an example of a generation method for the preset vibration signal with the genre “monotone” will be described. A vibration signal is generated with each of a plurality of pieces of monotone content (e.g., music, image scene). A representative vibration signal is generated by learning with the vibration signal of each piece of content. The representative vibration signal may be obtained as the preset vibration signal of “monotone.” The preset vibration signal of “monotone” can be used as vibration for monotone content.

Moreover, a lower-frequency vibration (e.g., 1/f fluctuation or stable vibration at 1 Hz or less) may be provided as the preset vibration signal other than one generated as the content. In this case, the vibration may be presented even if it is associated with the content reproduction or only the vibration may be reproduced without reproducing the content.

In a case where the vibration signal has not been specified by the audiovisual content (no in Step S405), the vibration signal selection unit 602 determines whether the vibration signal has been specified by the user (Step S407). In a case where the vibration signal has been specified by the user (yes in Step S407), the vibration signal selection unit 602 selects the vibration signal specified by the user (the audio vibration signal, the video vibration signal, or the preset vibration signal) (Step S408).

In a case where the vibration signal has not been specified by the user (no in Step S407), the vibration signal selection unit 602 determines whether the audiovisual content has metadata (Step S409). In a case where the audiovisual content has metadata (yes in Step S409), the vibration signal selection unit 602 selects the preset vibration signal 310 with the metadata 314 corresponding to the metadata of the audiovisual content (Step S410). Accordingly, even in a case of selecting the preset vibration signal 310 not depending on the audiovisual content, it is possible to select the preset vibration signal 310 relatively suitable for the audiovisual content, and it is expected that the user will be able to immerse themselves in the audiovisual content without feeling any discomfort when viewing it. Alternatively, the vibration signal selection unit 602 may select the vibration signal (the audio vibration signal, the video vibration signal, or the preset vibration signal) in accordance with the type of audiovisual content. For example, in a case where the audiovisual content is a racing game, it is possible to select the video vibration signal and generate vibration with a sense of presence or a sense of immersion. In a case where the audiovisual content is a movie, it is possible to select the audio vibration signal and generate vibration according to the background music.

On the other hand, in a case where the audiovisual content has no metadata (no in Step S409), the vibration signal selection unit 602 selects a default preset vibration signal selected in advance (Step S411). The vibration signal selection unit 602 outputs the selected vibration signal (Steps S401 to S411) to the drive signal generation unit 605 (Step S412). In this manner, by selecting the target vibration signal in accordance with the audiovisual content, it is possible to apply vibration suitable for the audiovisual content to the passenger of the vehicle 1, and the user experience is improved. The vibration signal may be used in this external vibrating apparatus, may be used in a vibrating apparatus (sheet, floor, handle, etc.) incorporated in the active suspension or the compartment, or may be used in combination.

### (5) Drive Signal Generation Unit

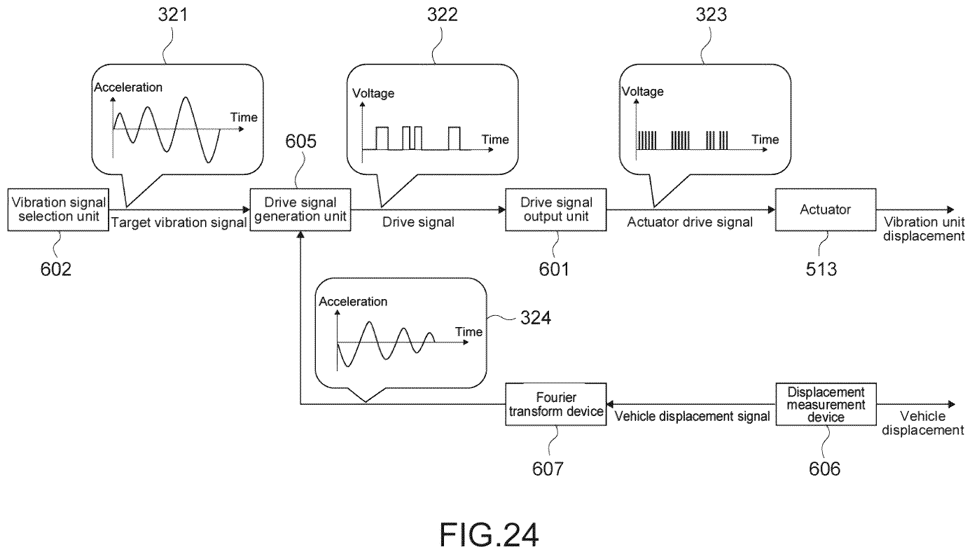

FIG. 24 shows operations (Step S109) of the drive signal generation unit and the surroundings.

The drive signal generation unit 605 obtains the vibration signal (Steps S401 to S411) selected by the vibration signal selection unit 602 as a target vibration signal 321. The target vibration signal 321 coincides with a target vibration waveform of the vehicle 1.

The drive signal generation unit 605 generates a drive signal 322 from the target vibration signal 321. The drive signal 322 is a voltage signal for driving the vibration apparatus 500 so that the vibration apparatus 500 vibrates the vehicle 1 with the target vibration signal 321. For example, the drive signal generation unit 605 generates the drive signal 322 by converting the peak of the target vibration signal 321 to a driving timing of the vibration apparatus 500.

The drive signal output unit 601 converts the drive signal 322 generated by the drive signal generation unit 605 to the actuator drive signal 323. The actuator drive signal 323 is a pulse on/off signal for actually driving the actuators 513. The drive signal output unit 601 outputs the actuator drive signal 323 to the actuators 513. In the vibration apparatus 500, the actuators 513 are driven in accordance with the actuator drive signal 323 to displace the roll bars 512.

The displacement measurement device 606 measures a displacement of the vehicle 1, calculates the displacement amount of the vehicle 1, and inputs the displacement amount to the Fourier transform device 607. The displacement measurement device 606 is a sensor that measures a displacement of a distance between the ground (tire contact surface) and the lower end of the vehicle body when the tires of the vehicle 1 comes into contact with the ground. The displacement measurement device 606 may be a camera or a time-of-flight (ToF) sensor, for example.

The Fourier transform device 607 Fourier-transforms the displacement amount of the vehicle 1 and generates a vehicle body vibration signal 324. The vehicle body vibration signal 324 is an actual vibration signal of the vehicle 1 vibrated by the vibration apparatus 500. The Fourier transform device 607 feeds back the generated vehicle body vibration signal 324 to the drive signal generation unit 605. Various methods are conceivable as how to push the vehicle 1. If the tires are pushed simply in the same cycle, they may be in opposite phase to the vibration of the vehicle body, and an excessive force is generated. Therefore, it is useful to control the vibration of the vehicle 1 by monitoring a pressure generated at the contact surface and making a feedback.

The drive signal generation unit 605 generates an adjustment vibration signal on the basis of the target vibration signal 321 and the vehicle body vibration signal 324. For example, the drive signal generation unit 605 is capable of generating an adjustment vibration signal by learning. The adjustment vibration signal is a vibration signal for making the vehicle body vibration signal 324 coincide with the target vibration signal 321. The drive signal generation unit 605 may apply representative characteristics of tires attenuation characteristics and generates an adjustment vibration signal. The drive signal generation unit 605 may apply suspension attenuation characteristics and generate an adjustment vibration signal. Since the suspension attenuation characteristics are included in the difference between the target vibration signal 321 and the vehicle body vibration signal 324 to be fed back, the drive signal generation unit 605 may generate an adjustment vibration signal without applying the suspension attenuation characteristics.

The drive signal generation unit 605 updates the drive signal 322 on the basis of the adjustment vibration signal and outputs it to the drive signal output unit 601. The drive signal output unit 601 converts the drive signal 322 generated by the drive signal generation unit 605 and outputs the actuators 513 to the actuator drive signal 323. In the vibration apparatus 500, the actuators 513 are driven in accordance with the actuator drive signal 323 to displace the roll bar 512. Accordingly, the vibration apparatus 500 is capable of vibrating the vehicle with the target vibration signal.

### (6) Vibration Control

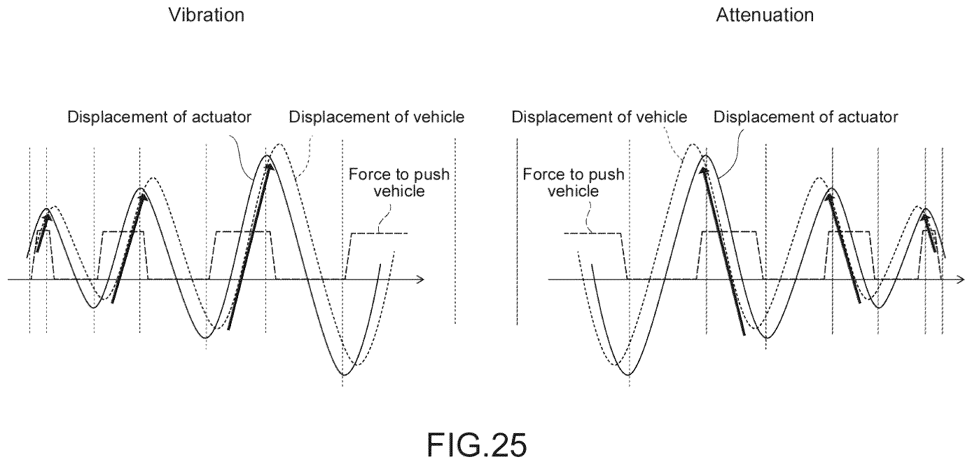

FIG. 25 is a conceptual diagram of vibration control.

When the displacement of the vibration apparatus 500 is generated during the vibration, the vibration apparatus 500 generates a force that pushes the vehicle 1. The displacement of the vehicle body is generated by the force that pushes the vehicle 1. Since the suspension has constantly applied bias in a direction that attenuates the amplitude, a return after displacement in a positive direction is smaller than the displacement in the positive direction. During the attenuation, it is opposite.

### (7) Modified Example of Control System Configuration

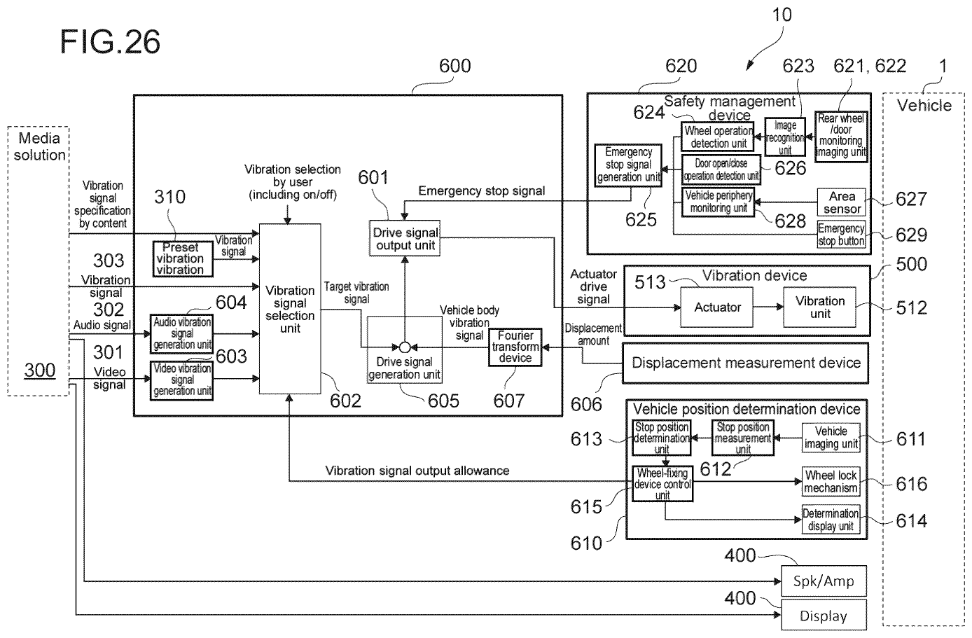

FIG. 26 shows a modified example of a control system configuration in which the installed-type vibration apparatus is utilized.

In the modified example, the vibration control apparatus 600, the safety management unit 620, the vibration apparatus 500, the displacement measurement device 606, and the vehicle position determination device 610 are independent and communicate with one another. As in the control system configuration in FIG. 14, the respective functional blocks may be incorporated in a single apparatus (vibration control apparatus 600) or may be distributed in a plurality of apparatuses as in the figure. The configuration of the vibration control apparatus 600 shown in FIG. 26 is similar to a configuration of the vibration control apparatus 600 described above with reference to FIG. 14. The configuration of the vehicle position determination device 610 shown in FIG. 26 is similar to a configuration of the vehicle position determination device 610 described above with reference to FIG. 16. The configuration of the safety management unit 620 shown in FIG. 26 is similar to a configuration of the safety management unit 620 described above with reference to FIG. 19.

### 6. Control System in Which Self-Propelled-Type Vibration Apparatus Is Utilized

### (1) Control System and Operation

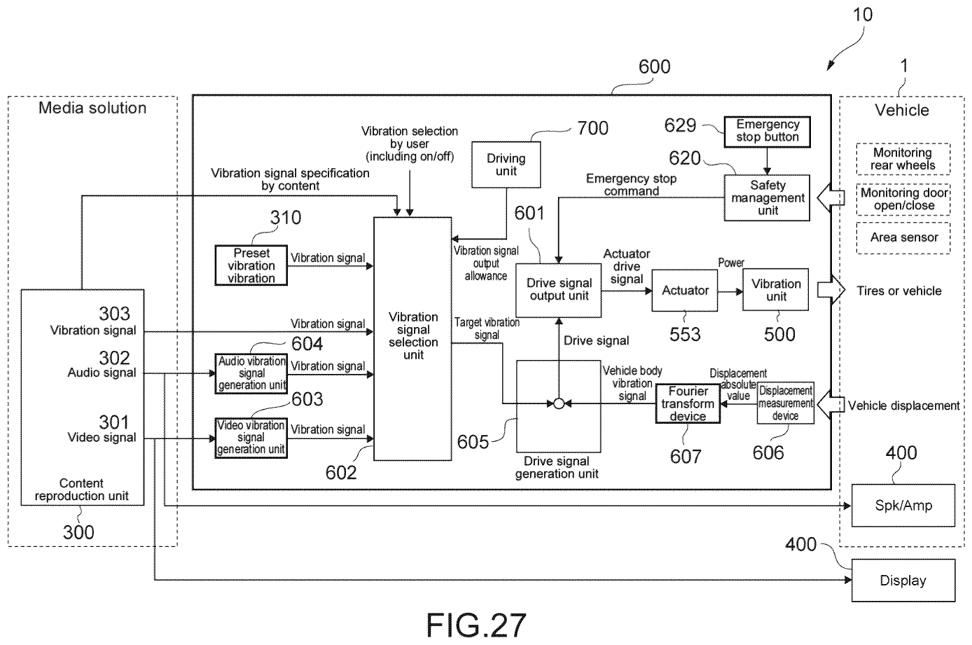

FIG. 27 shows an example of the control system configuration in which the self-propelled-type vibration apparatus is utilized.

Hereinafter, descriptions of configurations, operations, and the like similar to the already-mentioned configurations, operations, and the like will be omitted and different points will be mainly described.

In the control system configuration (FIG. 14) in which the installed-type vibration apparatus is utilized, the vibration control apparatus 600 includes the vehicle position determination device 610 and the vibration apparatus 500 pushes the front wheels 12 in an installed-type manner. On the other hand, in the control system configuration in which the self-propelled-type vibration apparatus is utilized, the vibration control apparatus 600 includes a driving unit 700 and the vibration apparatus 500 pushes the jack-up point 13 in a self-propelled-type manner. The driving unit 700 controls the self-propulsion of the vibration apparatus 500 and sends the vibration signal output allowance notification to the vibration signal selection unit 602. The system configuration of the vibration control apparatus 600 shown in FIG. 27 is similar to the system configuration of the vibration control apparatus 600 described above with reference to FIG. 14 except for the driving unit 700 provided instead of the vehicle position determination device 610 (FIG. 14). Both are similar for the other configurations.

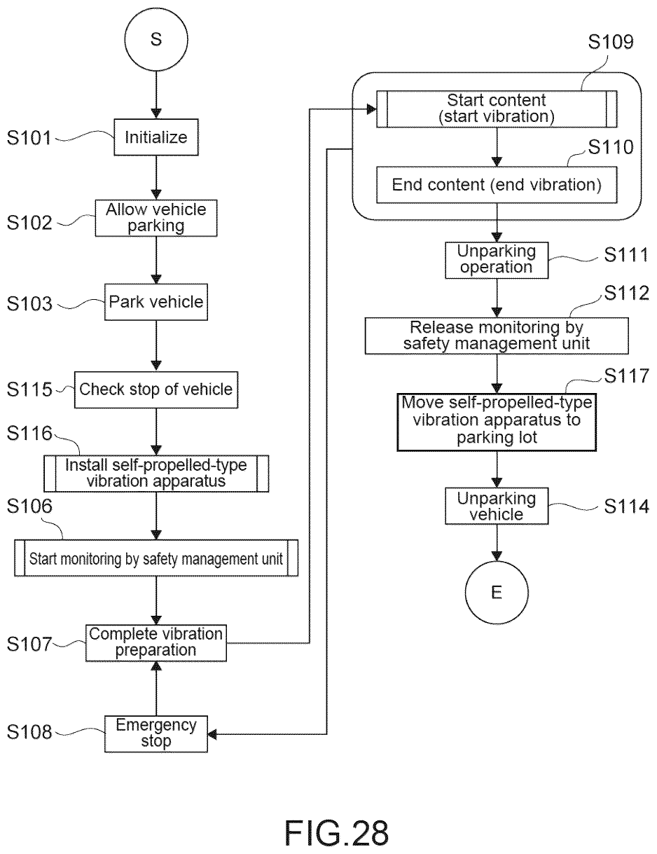

FIG. 28 shows an operation flow of the control system in which the self-propelled-type vibration apparatus is utilized.

In the installed-type vibration apparatus is utilized in the operation flow of the control system (FIG. 15), the vehicle position determination device 610 determines a stop position of the vehicle 1 (Step S104) and fixes the front wheels 12 of the vehicle 1 with the lock plates 511 of the vibration apparatus 500 (Step S105). When the vibration ends, the vehicle position determination device 610 releases the fixation of the front wheels 12 by the lock plates 511 of the vibration apparatus 500 (Step S113).

On the other hand, in the operation flow of the control system utilizing the self-propelled-type vibration apparatus, the driving unit 700 checks the position of the vehicle 1 (Step S115), and causes the vibration apparatus 500 to automatically move to be installed at the jack-up point 13 (Step S116).

When the vibration ends, the driving unit 700 causes the vibration apparatus 500 to automatically move to the parking lot (Step S117). Both are similar for the other operations.

### (2) Driving Unit

FIG. 29 shows a functional configuration of the driving unit.

The driving unit 700 includes a vehicle imaging unit 701, a vehicle type identification unit 702, a vehicle data acquisition unit 703, a vehicle stop position measurement unit 704, an environment map generation unit 705, a route computing unit 706, a control amount computing unit 707, a drive control unit 708, a brake control unit 709, a vehicle bottom imaging unit 710, a self-position estimation unit 711, an inertial information acquisition unit 712, a motion estimation unit 713, and an illumination apparatus 714.

In the driving unit 700, the vehicle imaging unit 701 generates image data of the vehicle 1 and sends it to the vehicle type identification unit 702 and the vehicle stop position measurement unit 704. The vehicle type identification unit 702 receives the image data from the vehicle imaging unit 701, identifies the vehicle type (type information) of the vehicle 1 on the basis of the image data, and sends the type information to the vehicle data acquisition unit 703. The vehicle data acquisition unit 703 receives the type information from the vehicle type identification unit 702 and obtains the data of the vehicle 1 on the basis of the type information. The data of the vehicle 1 includes three-dimensional data including the bottom and the jack-up point and a vehicle body size. The vehicle data acquisition unit 703 sends the vehicle body size to the vehicle stop position measurement unit 704 and sends the three-dimensional data of the vehicle 1 to the environment map generation unit 705. The vehicle stop position measurement unit 704 receives the image data from the vehicle imaging unit 701, receives the vehicle body size from the vehicle data acquisition unit 703, measures a stop position of the vehicle 1 on the basis of the image data and the vehicle body size, and sends the stop position information of the vehicle 1 to the environment map generation unit 705.

The environment map generation unit 705 receives the three-dimensional data from the vehicle data acquisition unit 703, receives the stop position information from the vehicle stop position measurement unit 704, generates an environment map on the basis of the three-dimensional data and the stop position information, and sends the environment map to the self-position estimation unit 711 and the route computing unit 706. The vehicle bottom imaging unit 710 generates image data by imaging the bottom of the vehicle 1 and sends the image data to the self-position estimation unit 711. The self-position estimation unit 711 receives the image data from the vehicle bottom imaging unit 710, receives the environment map from the environment map generation unit 705, and estimates a self-position of the vibration apparatus 500 with respect to the environment map on the basis of the image data and the environment map. The route computing unit 706 receives the environment map from the environment map generation unit 705, receives the self-position from the self-position estimation unit 711, generates a driving route on the basis of the environment map and the self-position, and sends the driving route to the control amount computing unit 707. The control amount computing unit 707 receives the driving route from the route computing unit 706, generates and outputs a driving control signal on the basis of the driving route, and drives the drive control unit 708 and the brake control unit 709 of the vibration apparatus 500.

During the self-propulsion of the vibration apparatus 500, the inertial information acquisition unit 712 obtains inertial data of the vibration apparatus 500 from the internal sensor of the vibration apparatus 500, and sends the inertial data to the motion estimation unit 713. The motion estimation unit 713 receives the inertial data from the inertial information acquisition unit 712, estimates a motion amount of the vibration apparatus 500 by converting the inertial data to the motion amount, and sends the motion amount information of the vibration apparatus 500 to the self-position estimation unit 711. The self-position estimation unit 711 receives the motion amount information of the vibration apparatus 500 from the motion estimation unit 713 and determines whether the vibration apparatus 500 reaches the bottom of the vehicle 1 on the basis of the motion amount information.

FIG. 30 shows the operation flow (Step S116) of the driving unit.

When the vehicle imaging unit 701 detects that the vehicle 1 has been parked (Step S103), the vehicle imaging unit 701 images the vehicle 1 (Step S501). The vehicle imaging unit 701 includes the camera 551 (FIG. 13) capable of capturing a visible light image, an IR image, a depth image, or the like. The vehicle type identification unit 702 identifies the vehicle type (type information) of the vehicle 1 on the basis of the image data captured by the vehicle imaging unit 701 (Step S502). The vehicle data acquisition unit 703 obtains the data of the vehicle 1 on the basis of the vehicle type (type information) of the vehicle 1 (Step S503). The data of the vehicle 1 includes the three-dimensional data including the bottom and the jack-up point and the vehicle body size. The type information and the data of the vehicle 1 may be registered in advance by the user or may be obtained by communication with the vehicle 1. The vehicle stop position measurement unit 704 measures a stop position of the vehicle 1 on the basis of the image data captured by the vehicle imaging unit 701 and the vehicle body size (Step S504).

The environment map generation unit 705 generates an environment map on the basis of the image data, the stop position of the vehicle 1, and the data of the vehicle 1 (Step S505). The environment map includes a plurality of voxels and shows the occupancy probability of each of the plurality of voxels. The environment map is, for example, an occupancy grid map (occupancy map). The occupancy grid map represents a spatial distribution of an object present in the environment by a three-dimensional position relationship in which the plurality of voxels (cubes) is stacked on each other and represents the probability (occupancy probability) at which the object is present in each voxel by color tone of each voxel. It should be noted that the environment map may represent the occupancy probability by a numeric value or function instead of the color tone. For example, the occupancy probability is represented by gradation of the color tones of the respective voxels like thermography so that voxels with high occupancy probability is red areas and voxels with low occupancy probability is blue areas.

The vehicle bottom imaging unit 710 generates image data by imaging the bottom of the vehicle 1. The self-position estimation unit 711 estimates a self-position of the vibration apparatus 500 with respect to the occupancy grid map (environment map) on the basis of the image data and the environment map. On the basis of the environment map and the self-position of the vibration apparatus 500, the route computing unit 706 generates a driving route up to the vibration position (position of the vibration apparatus 500 when vibrating the jack-up point) (Step S506). The control amount computing unit 707 generates and outputs a driving control signal on the basis of the driving route, drives the drive control unit 708 and the brake control unit 709 of the vibration apparatus 500, and controls the wheels 552 (FIG. 13) (Step S507).

During the self-propulsion of the vibration apparatus 500, the inertial information acquisition unit 712 obtains the inertial data of the vibration apparatus 500 from the internal sensor of the vibration apparatus 500 (Step S508). The internal sensor of the vibration apparatus 500 obtains data such as the angular velocity of the motor, an acceleration, and/or a rotational angle. The internal sensor is, for example, an inertial measurement unit (IMU) and/or a rotational angle encoder. The motion estimation unit 713 converts the inertial data of the vibration apparatus 500 to a motion amount to estimate the motion amount of the vibration apparatus 500 (Step S509).

The self-position estimation unit 711 determines whether the vibration apparatus 500 has reached the bottom of the vehicle 1 (Step S510). When the vibration apparatus 500 has reached the bottom of the vehicle 1 (yes in Step S510), the vehicle bottom imaging unit 710 images the bottom of the vehicle 1 and generates image data (Step S511). The ceiling of the parking area may be equipped with a marker for position measurement so that the position of the vehicle itself can be measured even in a situation where it is difficult to image the vehicle bottom. On the basis of the result of imaging, the self-position estimation unit 711 determines whether the illuminance is appropriate (Step S512). In a case where the illuminance is inappropriate (no in Step S512), the self-position estimation unit 711 adjusts the illuminance of the illumination apparatus 714 (Step S513).

In a case where the illuminance is appropriate (yes in Step S512), the self-position estimation unit 711 estimates a self-position of the vibration apparatus 500 with respect to the occupancy grid map (environment map) on the basis of the image data (Step S514) and the environment map (Step S515). The self-position estimation unit 711 determines whether the vibration apparatus 500 has reached the vibration position (position of the vibration apparatus 500 when vibrating the jack-up point) (Step S516). The driving unit 700 repeats the processing until the vibration apparatus 500 reaches the vibration position (position of the vibration apparatus 500 when vibrating the jack-up point) (no in Step S516). When the vibration apparatus 500 has reached the vibration position (yes in Step S516), the driving unit 700 notifies the vibration signal selection unit 602 of the vibration signal output allowance (Step S517).

Then, when the operation of unparking the vehicle 1 is started (Step S111), the movement of the vibration apparatus 500 is instructed (Step S518). The driving unit 700 moves the vibration apparatus 500 to a prescribed position (Step S519).

### (3) Modified Example of Control System Configuration

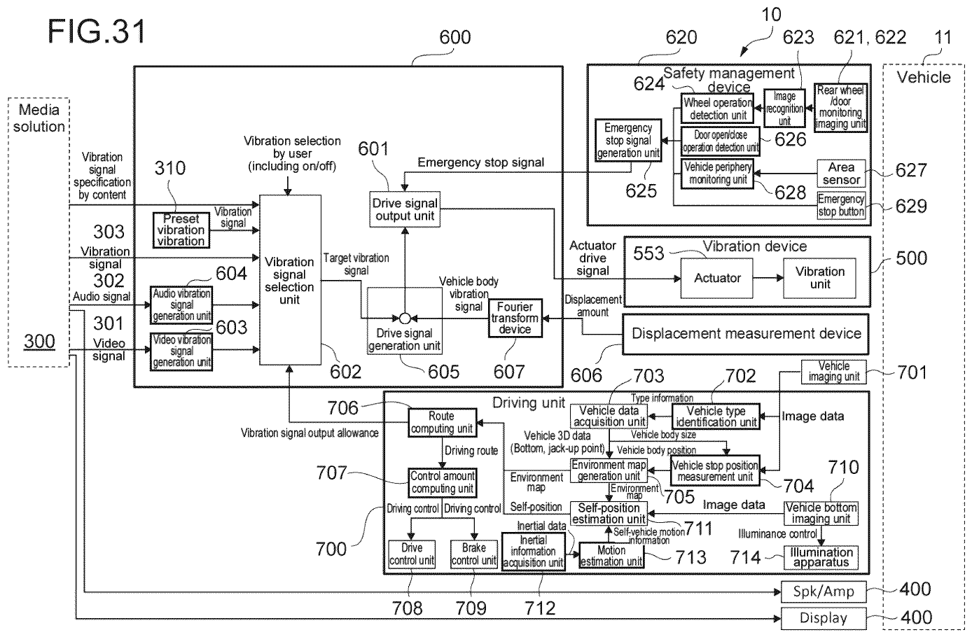

FIG. 31 shows a modified example of the control system configuration in which the installed-type vibration apparatus is utilized.

In the modified example, the vibration control apparatus 600, the safety management unit 620, the vibration apparatus 500, the displacement measurement device 606, and the driving unit 700 are independent and communicate with each other. As in the control system configuration of FIG. 27, the respective functional blocks may be incorporated in a single apparatus (vibration control apparatus 600) or may be distributed in a plurality of apparatuses as in the figure. The configuration of the vibration control apparatus 600 shown in FIG. 31 is similar to a configuration of the vibration control apparatus 600 described above with reference to FIG. 14. The configuration of the driving unit 700 shown in FIG. 31 is similar to a configuration of the driving unit 700 described above with reference to FIG. 16. The configuration of the safety management unit 620 shown in FIG. 31 is similar to a configuration of the safety management unit 620 described above with reference to FIG. 19.

### 7. Configuration Example of Vehicle Control System

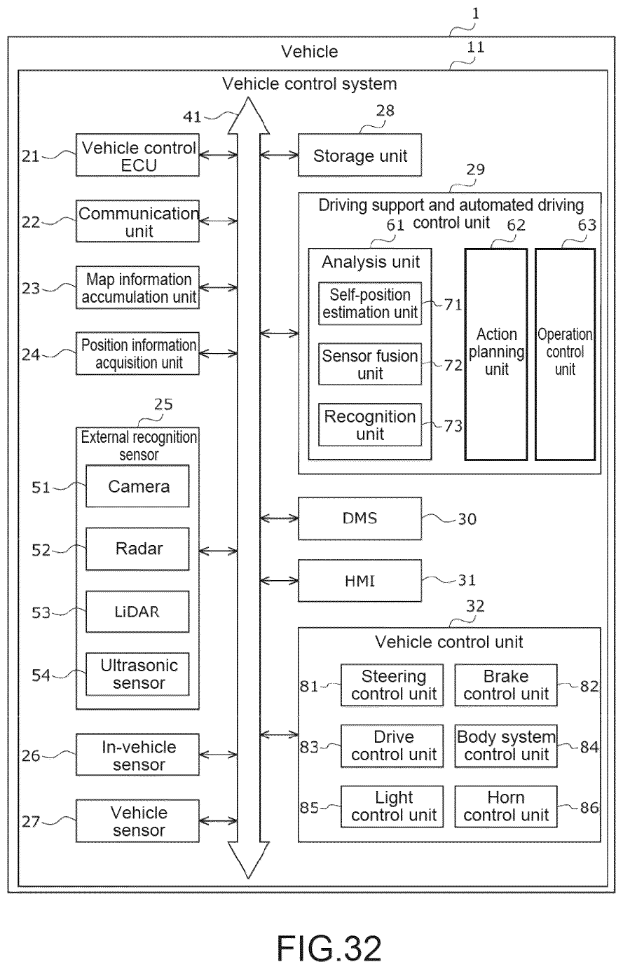

FIG. 32 is a block diagram showing a configuration example of a vehicle control system 11 that is an example of a movement apparatus control system to which the present technology is applied.

The vehicle control system 11 is provided in the vehicle 1 and performs processing associated with automated driving of the vehicle 1. The automated driving includes automated driving of levels 1 to 5 and remote driving and remote assistance of the vehicle 1 by the remote driver.

The vehicle control system 11 includes a vehicle control electronic control unit (ECU) 21, a communication unit 22, a map information accumulation unit 23, a position information acquisition unit 24, an external recognition sensor 25, an in-vehicle sensor 26, a vehicle sensor 27, a storage unit 28, an automated driving control unit 29, a driver monitoring system (DMS) 30, a human machine interface (HMI) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the automated driving control unit 29, the DMS 30, the HMI 31, and the vehicle control unit 32 are connected to be capable of communicating with one another via the communication network 41. The communication network 41 is constituted by a vehicle-mounted communication network, a bus, and the like compatible with the digital bidirectional communication standards, for example, a controller area network (CAN), a local interconnect network (LIN), a local area network (LAN), FlexRay (registered trademark), and Ethernet (registered trademark). The communication networks 41 may be used for each type of data to be transmitted. For example, the CAN may be applied to data related to vehicle control and Ethernet may be applied to high-volume data. It should be noted that the respective units of the vehicle control system 11 may be directly connected by wireless communication assuming communication at a relatively near distance, for example, near-field communication (NFC) or Bluetooth (registered trademark), not via the communication network 41.

It should be noted that hereinafter, in a case where the respective units of the vehicle control system 11 perform communication via the communication network 41, the description of the communication network 41 will be omitted. For example, in a case where the vehicle control ECU 21 and the communication unit 22 perform communication via the communication network 41, it will be simply described that the vehicle control ECU 21 and the communication unit 22 perform communication.

The vehicle control ECU 21 is constituted by various processors, for example, a central processing unit (CPU) and a micro processing unit (MPU). The vehicle control ECU 21 controls all or some of the functions of the vehicle control system 11.

The communication unit 22 communicates with various apparatuses inside and outside the vehicle, such as other vehicles, servers, and base stations, and transmits/receives various types of data. At this time, the communication unit 22 is capable of communicating with a plurality of communication schemes.

The outside-vehicle communication that can be executed by the communication unit 22 will be schematically described. The communication unit 22 communicates with a server present in an external network (hereinafter, referred to as external server) and the like via the base station or the access point by a wireless communication method, for example, 5G (5th generation mobile communication system), or long term evolution (LTE), dedicated short range communications (DSRC). The external network for the communication of the communication unit 22 is, for example, the Internet, a cloud network, or a network specific to a company. The communication scheme performed by the communication unit 22 on the external network is not particularly limited as long as it is a wireless communication method capable of performing digital bidirectional communication at a communication speed above a predetermined level and at a distance above a predetermined level.

Also, for example, the communication unit 22 is capable of communicating with a terminal present near the vehicle itself by using a peer to peer (P2P) technology. A terminal present near the vehicle itself is, for example, a terminal worn by a mobile object that moves at a relatively low speed, such as a pedestrian or a bicycle, a terminal installed at a fixed position, such as a store, or a machine type communication (MTC) terminal. In addition, the communication unit 22 can also perform V2X communication. The V2X communication refers to, for example, communication between the vehicle itself and the others, such as vehicle-to-vehicle (V2V) communication with other vehicles, vehicle-to-infrastructure (V2I) communication with road-side units and the like, vehicle-to-home (V2H) communication with homes, and vehicle-to-pedestrian (V2P) communication with terminals carried by pedestrians and the like.

The communication unit 22 is capable of receiving a program from the outside (Over The Air) for updating software that controls, for example, the operation of the vehicle control system 11. The communication unit 22 is capable of further receiving the map information, the traffic information, information about the periphery of the vehicle 1, and the like from the outside. Moreover, for example, the communication unit 22 is capable of sending the information related to the vehicle 1, the information about the periphery of the vehicle 1, and the like to the outside. Examples of the information related to the vehicle 1 that the communication unit 22 sends to the outside includes data indicating the state of the vehicle 1, a recognition result by a recognition unit 73, and the like. In addition, for example, the communication unit 22 performs communication compatible with a vehicle emergency alarm system, such as eCall.

For example, the communication unit 22 receives an electromagnetic wave sent by a vehicle information and communication system (VICS) (registered trademark), such as a radio beacon, an optical beacon, or FM multiplex broadcasting.

The in-vehicle communication that can be executed by the communication unit 22 will be schematically described. The communication unit 22 is capable of communicating with each in-vehicle apparatus by wireless communication, for example. The communication unit 22 is capable of wirelessly communicating with the in-vehicle apparatus by a communication scheme capable of performing the digital bidirectional communication at a communication speed above a predetermined level by wireless communication, for example, a wireless LAN, Bluetooth, NFC, or a wireless USB (WUSB). Not limited thereto, the communication unit 22 can also communicate with each in-vehicle apparatus by wired communication. For example, the communication unit 22 is capable of communicating with each in-vehicle apparatus by wired communication via a cable connected to a connection terminal (not shown). The communication unit 22 is capable of communicating with each in-vehicle apparatus by a communication scheme capable of performing digital bidirectional communication at a communication speed above a predetermined level by wired communication, for example, a universal serial bus (USB), a high-definition multimedia interface (HDMI) (registered trademark), or a mobile high-definition link (MHL).

Here, the in-vehicle apparatus refers to, for example, an apparatus not connected to the communication network 41 in a vehicle. For example, a mobile apparatus or a wearable apparatus possessed by a user inside the vehicle, such as a driver, an information apparatus carried in a vehicle and temporarily installed, or the like is assumed as the in-vehicle apparatus.

The map information accumulation unit 23 accumulates one or both of a map obtained from the outside and a map generated by the vehicle 1. For example, the map information accumulation unit 23 accumulates a three-dimensional high-accuracy map, a global map that covers an area lower in accuracy and broader than the high-accuracy map, and the like.

The high-accuracy map is, for example, a dynamic map, a point cloud map, or a vector map. The dynamic map is a map consisting of four layers, e.g., dynamic information, quasi-dynamic information, quasi-static information, and static information, and is provided in the vehicle 1 from the external server or the like. The point cloud map is a map configured by a point cloud (point cloud data). The vector map is a map that has been adapted for automated driving by mapping traffic information such as the positions of lanes and traffic lights to point cloud maps, for example.

The point cloud map and the vector map may be provided from the external server, for example. Alternatively, the point cloud map and the vector map may be generated by the vehicle 1 as a map for performing matching with a local map to be described later on the basis of sensing results of a camera 51, a radar 52, a LiDAR 53, and the like and accumulated by the map information accumulation unit 23. Moreover, in a case where the high-accuracy map is provided from the external server or the like, for example, map data of several hundred meter square regarding a plan path where the vehicle 1 is to travel, is acquired from the external server or the like in order to reduce the communication volume.

The position information acquisition unit 24 receives a GNSS signal from a global navigation satellite system (GNSS) satellite and obtains position information of the vehicle 1. The obtained position information is supplied to the automated driving control unit 29. It should be noted that the position information acquisition unit 24 is not limited to a method using the GNSS signal, and, for example, position information may be obtained using a beacon.

The external recognition sensor 25 includes various sensors used for recognizing the situation outside the vehicle 1 and supplies sensor data from each sensor to the respective units of the vehicle control system 11. The type and number of the sensors of the external recognition sensor 25 are arbitrary.

For example, the external recognition sensor 25 includes the camera 51, the radar 52, the light detection and ranging, laser imaging detection and ranging (LiDAR) 53, and an ultrasonic sensor 54. Not limited thereto, the external recognition sensor 25 may be configured to include one or more types of sensors of the camera 51, the radar 52, the LiDAR 53, and the ultrasonic sensor 54. The number of cameras 51, radars 52, LiDARs 53, and ultrasonic sensors 54 is not particularly limited as long as they can be installed in the vehicle 1 in reality. Moreover, the types of sensors of the external recognition sensor 25 are not limited to this example, and the external recognition sensor 25 may include other types of sensors. An example of a sensing region of each sensor of the external recognition sensor 25 will be described later.

It should be noted that the imaging method of the camera 51 is not particularly limited. Cameras with various imaging methods, such as a time of flight (ToF) camera, a stereo camera, a monocular camera, and an infrared camera, which are imaging methods capable of performing distance measurement, can be applied to the camera 51 depending on needs. Not limited thereto, the camera 51 may be for simply obtaining a captured image, not related to the distance measurement.

Moreover, for example, the external recognition sensor 25 can include an environment sensor for detecting an environment with respect to the vehicle 1. The environment sensor is a sensor for detecting an environment, such as weather, climate, and brightness, and can include various sensors, for example, raindrop sensors, fog sensors, sunshine sensors, snow sensors, and illuminance sensors.

In addition, for example, the external recognition sensor 25 includes microphones used for detection and the like of positions of sounds and sound sources in the periphery of the vehicle 1.

The in-vehicle sensor 26 includes various sensors for detecting the in-vehicle information and supplies the sensor data from each sensor to the respective units of the vehicle control system 11. The type and number of the various sensors of the in-vehicle sensor 26 are not particularly limited as long as they can be installed in the vehicle 1 in reality.

For example, the in-vehicle sensor 26 can include one or more types of sensors of a camera, a radar, a seat sensor, a steering wheel sensor, a microphone, and a biometric sensor. For example, cameras with various imaging methods capable of performing distance measurement, such as a ToF camera, a stereo camera, a monocular camera, or an infrared camera, can be used as the camera of the in-vehicle sensor 26. Not limited thereto, the camera of the in-vehicle sensor 26 may be for simply obtaining a captured image, not related to the distance measurement. The biometric sensor of the in-vehicle sensor 26 is provided in, for example, a sheet or a steering wheel, and detects various types of biometric information of the user.

The vehicle sensor 27 includes various sensors for detecting the state of the vehicle 1, and supplies the sensor data from each sensor to the respective units of the vehicle control system 11. The type and number of various sensors of the vehicle sensor 27 are not particularly limited as long as they can be installed in the vehicle 1 in reality.

For example, the vehicle sensor 27 includes a speed sensor, an acceleration sensor, an angular velocity sensor (gyro sensor), and an inertial measurement unit (IMU) integrating them. For example, the vehicle sensor 27 includes a steering angle sensor that detects the steering angle of the steering wheel, a yaw rate sensor, an accelerator sensor that detects the amount of operation of the accelerator pedal, and a brake sensor that detects the amount of operation of the brake pedal. For example, the vehicle sensor 27 includes a rotation sensor that detects the number of rotations of the engine or motor, a tire pressure sensor that detects a tire pressure, a slip rate sensor that detects a tire slip rate, and a wheel speed sensor that detects a wheel rotation speed. For example, the vehicle sensor 27 includes a battery sensor that detects remaining battery charge and temperature, and a shock sensor that detects external impacts.

The storage unit 28 includes at least one of a nonvolatile storage medium and a volatile storage medium and stores data and programs. The storage unit 28 is used as, for example, an electrically erasable programmable read only memory (EEPROM) and a random access memory (RAM). A magnetic storage device, such as a hard disc drive (HDD), a semiconductor storage device, an optical storage device, and a magneto-optical storage device can be applied as the storage medium. The storage unit 28 stores various types of programs and data used by the respective units of the vehicle control system 11. For example, the storage unit 28 includes an event data recorder (EDR) and data storage system for automated driving (DSSAD) and stores information of the vehicle 1 before and after an event, such as an accident, and information acquired by the in-vehicle sensor 26.

The automated driving control unit 29 controls the automated driving function of the vehicle 1. For example, the automated driving control unit 29 includes an analysis unit 61, an action planning unit 62, and an operation control unit 63.

The analysis unit 61 performs analysis processing of the vehicle 1 and the surrounding situation. The analysis unit 61 includes a self-position estimation unit 71, a sensor fusion unit 72, and the recognition unit 73.

The self-position estimation unit 71 estimates the self-position of the vehicle 1 on the basis of the sensor data from the external recognition sensor 25 and the high-accuracy map accumulated in the map information accumulation unit 23. For example, the self-position estimation unit 71 generates a local map on the basis of the sensor data from the external recognition sensor 25 and performs matching between the local map and the high-accuracy map, thereby estimating the self-position of the vehicle 1. The position of the vehicle 1 is, for example, based on the center of the rear axle.

The local map is, for example, a three-dimensional high-accuracy map or an occupancy grid map generated by using a technology such as simultaneous localization and mapping (SLAM). The three-dimensional high-accuracy map is, for example, the above-mentioned point cloud map. The occupancy grid map is a map dividing a three-dimensional or two-dimensional space in the periphery of the vehicle 1 in a grid with a predetermined size and showing an occupancy state of the object in units of grids. The occupancy state of the object is indicated for example as the presence/absence or presence probability of the object. The local map is also used for detection processing and recognition processing of the situation outside the vehicle 1 by the recognition unit 73, for example.

It should be noted that the self-position estimation unit 71 may estimate the self-position of the vehicle 1 on the basis of the position information acquired by the position information acquisition unit 24 and the sensor data from the vehicle sensor 27.

The sensor fusion unit 72 performs sensor fusion processing of obtaining information by combining a plurality of different types of sensor data (e.g., image data supplied from the camera 51 and sensor data supplied from the radar 52). The method of combining different types of sensor data includes combination, integration, fusion, unification, and the like.

The recognition unit 73 performs detection processing of detecting the situation outside the vehicle 1 and recognition processing of recognizing the situation outside the vehicle 1.

For example, the recognition unit 73 performs the detection processing and recognition processing of the situation outside the vehicle 1 on the basis of information from the external recognition sensor 25, information from the self-position estimation unit 71, information from the sensor fusion unit 72, and the like.

Specifically, for example, the recognition unit 73 performs the detection processing, the recognition processing, and the like of the object in the periphery of the vehicle 1. The detection processing of the object is processing of detecting, for example, the presence/absence, the size, the shape, the position, and the motion, of the object. The recognition processing for the object is, for example, processing of recognizing an attribute, such as the type of object, or identifying a particular object. It should be noted that the detection processing and the recognition processing are not necessarily clearly divided, and may overlap each other.

For example, the recognition unit 73 detects the object in the periphery of the vehicle 1 by performing clustering of classifying the point cloud based on the sensor data by the radar 52, the LiDAR 53, or the like for each mass of the point cloud. Accordingly, the presence/absence, the size, the shape, and the position of the object in the periphery of the vehicle 1 are detected.

For example, the recognition unit 73 detects a motion of the object in the periphery of the vehicle 1 by performing tracking following the motion of the mass of the point cloud classified by the clustering. Accordingly, the speed and the travelling direction (movement vector) of the object in the periphery of the vehicle 1 are detected.

For example, the recognition unit 73 detects or recognizes a vehicle, a person, a bicycle, an obstacle, a structure, a road, a traffic light, a traffic sign, a road sign, and the like on the basis of the image data supplied from the camera 51. Moreover, the recognition unit 73 may recognize a type of the object in the periphery of the vehicle 1 by performing recognition processing, such as semantic segmentation.

For example, the recognition unit 73 is capable of performing recognition processing of the traffic rules in the periphery of the vehicle 1 on the basis of a map accumulated in the map information accumulation unit 23, an estimation result of a self-position by the self-position estimation unit 71, and a recognition result of the object in the periphery of the vehicle 1 by the recognition unit 73. The recognition unit 73 is capable of recognizing the position and states of the traffic lights, the contents of the traffic signs and road signs, the contents of traffic restrictions, a lane where driving is possible, and the like by this processing.

For example, the recognition unit 73 is capable of performing the recognition processing of the environment in the periphery of the vehicle 1. As the surrounding environment to be recognized by the recognition unit 73, weather, temperature, humidity, brightness, road conditions, and the like are assumed.

The action planning unit 62 generates an action plan of the vehicle 1. For example, the action planning unit 62 generates an action plan by performing processing of planning a path and following the path.

It should be noted that planning a path includes global path planning and local path planning. The global path planning includes processing of planning a rough path from the start to the goal. The local path planning can also be called track plan, and includes processing of generating a track, which is near the vehicle 1 and enables safe and smooth driving in consideration of the motion characteristics of the vehicle 1, in the planned path.

Following the path is processing of planning an operation for safe and correct driving on the path planned by planning the path in the planned time. The action planning unit 62 is capable of calculating the target speed and the target angular velocity of the vehicle 1 on the basis of a result of this processing of following the path, for example.

The operation control unit 63 controls the operation of the vehicle 1 in order to realize the action plan generated by the action planning unit 62.

For example, the operation control unit 63 controls a steering control unit 81, a brake control unit 82, and a drive control unit 83, which is included in the vehicle control unit 32 to be described later, and performs lateral vehicle motion control and longitudinal vehicle motion control so that the vehicle 1 travels on the track calculated by the track plan. For example, the operation control unit 63 performs control for the purpose of driver support functions such as collision avoidance or impact mitigation, cruise control, speed maintenance, collision warnings for the vehicle itself, lane departure warnings for the vehicle itself, etc., and automated driving such as driving without the operation of the driver or remote driver.

The DMS 30 performs authentication processing of the driver, recognition processing of the driver's state, and the like on the basis of the sensor data from the in-vehicle sensor 26, the input data input to the HMI 31 to be described later, and the like. The driver's state to be recognized includes, for example, physical condition, alertness, concentration, fatigue, line of sight, intoxication, driving operation, and posture.

It should be noted that the DMS 30 may perform authentication processing of a user other than the driver and recognition processing of a state of the user. Moreover, for example, the DMS 30 may perform recognition processing of an in-vehicle situation on the basis of the sensor data from the in-vehicle sensor 26. Examples of the in-vehicle situation to be recognized includes temperature, humidity, brightness, and smell.

The HMI 31 inputs various types of data, instructions, and the like and presents the various types of data to the user.

The data input by the HMI 31 will be schematically described. The HMI 31 includes an input device for a person to input data. The HMI 31 generates an input signal on the basis of the data, instruction, and the like input by the input device and supplies it to the respective units of the vehicle control system 11. The HMI 31 includes operation elements, for example, a touch panel, a button, a switch, and a lever, as input devices. Not limited thereto, the HMI 31 may further include an input device capable of inputting information by a method other than a manual operation by voice, gesture, or the like. In addition, the HMI 31 may use, for example, a remote control apparatus using infrared rays or radio waves, a mobile apparatus compatible with the operation of the vehicle control system 11, or an external connection apparatus, such as a wearable apparatus, as input devices.

The data presentation by the HMI 31 will be schematically described. The HMI 31 generates visual information, auditory information, and tactile information with respect to the user or the outside of the vehicle. Moreover, the HMI 31 performs output control to control the output, output contents, output timing, output method, and the like of each piece of information generated. The HMI 31 generates and outputs information shown as image and light, for example, an operation screen, a display state of the vehicle 1, warning display, and a monitor image showing the surrounding situation of the vehicle 1 as the visual information. Moreover, the HMI 31 generates and outputs information shown as sound, for example, voice guidance, warning sounds, or warning messages, as the auditory information. In addition, the HMI 31 generates and outputs information provided as a sense of touch to the user, for example, force, vibration, and motion, as the tactile information.

As an output device by which the HMI 31 outputs the visual information, for example, a display apparatus that presents the visual information by displaying the image by itself and a projector apparatus that presents the visual information by projecting the image can be applied. It should be noted that the display apparatus may be an apparatus that displays the visual information in the field-of-view of the user, for example, a head-up display, a see-through display, or a wearable device with an augmented reality (AR) function, other than a display apparatus with a normal display. Moreover, the HMI 31 can also use a navigation apparatus provided in the vehicle 1, an instrument panel, a camera monitoring system (CMS), an electronic mirror, or a display device of a lamp or the like, as the output device that outputs the visual information.

For example, a sound speaker, headphones, or earphones can be applied as the output device by which the HMI 31 outputs the auditory information.

As the output device by which the HMI 31 outputs the tactile information, a haptics element using a haptics technology for example can be applied. The haptics element is provided in a portion touched by the user, for example, the steering wheel or the sheet.

The vehicle control unit 32 controls the respective parts of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like on a state of a steering system of the vehicle 1. The steering system includes, for example, a steering mechanism including the steering wheel and the like, an electric power steering, and the like. The steering control unit 81 includes, for example, a steering ECU that controls the steering system, an actuator that drives the steering system, and the like.

The brake control unit 82, for example, detects and controls a state of a brake system of the vehicle 1. The brake system includes, for example, a brake mechanism including a brake pedal and the like, antilock brake system (ABS), a regenerative brake mechanism, and the like. The brake control unit 82 includes, for example, a brake ECU that controls the brake system, an actuator that drives the brake system, and the like.

The drive control unit 83, for example, detects and controls a state of a driving system of the vehicle 1. The driving system includes, for example, a driving force generation apparatus for generating a driving force of an accelerator pedal, an internal-combustion engine, a motor for driving, and the like, a driving force transmission mechanism for transmitting the driving force to the wheels, and the like. The drive control unit 83 includes, for example, a driving ECU that controls the driving system, an actuator that drives the driving system, and the like.

The body system control unit 84 for example detects and controls a state of a body-system system of the vehicle 1. The body-system system includes, for example, a keyless entry system, a smart key system, a power window apparatus, a power seat, an air conditioning apparatus, an air bag, a seat belt, and a shift lever. The body system control unit 84 includes, for example, a body system ECU that controls the body-system system and an actuator that drives the body-system system.

The light control unit 85 for example detects and controls states of various lights of the vehicle 1. Examples of lights to be controlled include headlights, back lights, fog lights, turn signals, brake lights, projections, and bumper indicators. The light control unit 85 includes a light ECU that controls the lights and an actuator that drives the lights.

The horn control unit 86 for example detects and controls a state of a car horn of the vehicle 1. The horn control unit 86 includes, for example, a car ECU that controls the car horn and an actuator that drives the car horn.

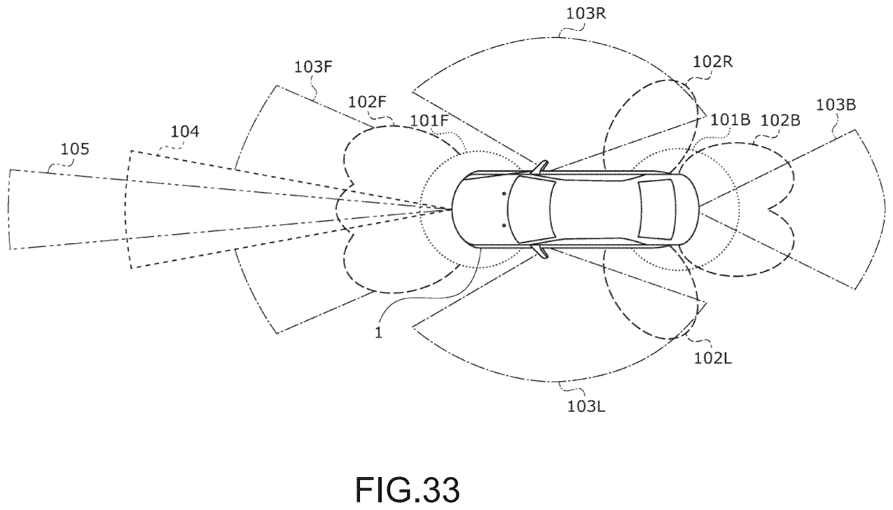

FIG. 33 is a diagram showing an example of a sensing region of the camera 51, the radar 52, the LiDAR 53, and the ultrasonic sensor 54, and the like of the external recognition sensor 25. It should be noted that in the figure, a state as the vehicle 1 is viewed from the upper surface is schematically shown, and the left end side is a front end (front) side of the vehicle 1 and the right end side is a rear end (rear) side of the vehicle 1.

A sensing region 101F and a sensing region 101B shows an example of a sensing region of the ultrasonic sensor 54. The sensing region 101F covers the front end periphery of the vehicle 1 by a plurality of ultrasonic sensors 54. The sensing region 101B covers the rear end periphery of the vehicle 1 by the plurality of ultrasonic sensors 54.

Sensing results of the sensing region 101F and the sensing region 101B are used for, for example, parking support of the vehicle 1.

The sensing regions 102F to 102B show an example of the sensing regions of the radar 52 for short distance and middle distance. The sensing region 102F covers a position farther than the sensing region 101F in front of the vehicle 1. The sensing region 102B covers a position farther than the sensing region 101B behind the vehicle 1. A sensing region 102L covers the rear left side periphery of the vehicle 1. A sensing region 102R covers the rear right side periphery of the vehicle 1.

Sensing results of the sensing region 102F are used for, for example, detecting the vehicle, the pedestrian, and the like present in front of the vehicle 1. Sensing results of the sensing region 102B are used for, for example, collision preventing function behind the vehicle 1. Sensing results of the sensing region 102L and the sensing region 102R are used for, for example, detecting objects in side dead zones of the vehicle 1.

Sensing regions 103F to 103B show an example of sensing regions of the camera 51. The sensing region 103F covers a position farther than the sensing region 102F in front of the vehicle 1. The sensing region 103B covers a position farther than the sensing region 102B behind the vehicle 1. A sensing region 103L covers the left side periphery of the vehicle 1. The sensing region 103R covers the right side periphery of the vehicle 1.

Sensing results of the sensing region 103F can be used for, for example, recognition of traffic lights and traffic signs, the lane departure preventing support system, and an automatic headlight control system. Sensing results of the sensing region 103B can be used for, for example, parking support and a surround view system. Sensing results of the sensing region 103L and the sensing region 103R can be used for, for example, the surround view system.

A sensing region 104 shows an example of a sensing region of the LiDAR 53. The sensing region 104 covers a position farther than the sensing region 103F in front of the vehicle 1. On the other hand, the sensing region 104 has a range in the left and right directions which is narrower than the sensing region 103F.

Sensing results of the sensing region 104 are used for, for example, detecting objects, such as surrounding vehicles.

The sensing region 105 shows an example of sensing regions of the radar 52 for a long distance. The sensing region 105 covers a position farther than the sensing region 104 in front of the vehicle 1. On the other hand, the sensing region 105 has a range in the left and right directions which is narrower than the sensing region 104.

Sensing results of the sensing region 105 are used for, for example, adaptive cruise control (ACC), emergency brake, and collision avoidance.

It should be noted that the sensing regions of the respective sensors of the camera 51, the radar 52, the LiDAR 53, and the ultrasonic sensor 54 including the external recognition sensor 25 may take various configurations other than those shown in the figure. Specifically, the ultrasonic sensor 54 may sense also the sides of the vehicle 1 and the LiDAR 53 may sense the back of the vehicle 1. Moreover, the mounting positions of the respective sensors are not limited to those respective examples described above. Moreover, the number of sensors may be one or may be plural.

Here, although the vehicle 1 has the automated driving function in the above description, the vehicle vibration system in the present example, the vehicle 1 does not need to have the automated driving function.

Moreover, it is conceivable that the vehicle 1 is an electric vehicles (EV) in which an electric motor powered by electricity is used as a power source. Moreover, the vehicle 1 may be a gasoline-powered vehicle that uses an internal-combustion engine fueled by gasoline as a power source or may be a hybrid car in which an internal-combustion engine and an electric motor are both used as a power source.

### 8. Conclusion

In the present embodiment, the passenger is enabled to view audiovisual content while the EV is being charged at the EV charging station. While the passenger is viewing the audiovisual content, vibration depending on the content is provided to the vehicle from the outside and a realistic viewing experience is realized. For example, while a commercially available EV vehicle is being charged, vibration linked to the content or vibration that feels pleasant is intentionally applied to the vehicle from a portion partially in contact with the outside.

In the present embodiment, the front wheel or the jack-up point is employed as the vibration point that comes into contact with the vehicle 1 and vibrates the vehicle 1. If the front wheel or the jack-up point is vibrated, it is possible to vibrate the vehicle 1 with as little energy as possible and without causing damage to the vehicle body (body scratches, tire wear), and make the passenger feel the vibration.

Accordingly, unlike technologies that place the vehicle on a dedicated vibration machine, such as 6DOF installed, or technologies that intentionally apply vibration to measure the durability of the vehicle, it is possible to adapt to various places and conditions and simply and conveniently control the vehicle vibration. Accordingly, the user will be able to spend the charging time at the EV charging station in a more enjoyable way.

In the present embodiment, the vibration control apparatus 600 feeds back the actual vehicle body vibration signal 324 of the vehicle 1 vibrated by the vibration apparatus 500 and generates an adjustment vibration signal on the basis of the target vibration signal 321 and the vehicle body vibration signal 324. The vibration control apparatus 600 updates the drive signal 322 on the basis of the adjustment vibration signal. Accordingly, the vibration apparatus 500 is capable of vibrating the vehicle with the target vibration signal. Accordingly, a suitable vibration can be applied to the passenger of the vehicle 1, and the user experience is improved. Accordingly, the user will be able to spend the charging time at the EV charging station in a more enjoyable way.

The present disclosure may include the following configurations.
(1) A vibration control apparatus, including:
a vibration signal selection unit that selects a target vibration signal that is a target vibration waveform; and
a drive signal generation unit that
   generates a drive signal to be output to a vibration apparatus in order for the vibration apparatus that comes into contact with a vehicle and vibrates the vehicle from outside to vibrate the vehicle with the target vibration signal,
   obtains a vehicle body vibration signal that is a vibration signal of the vehicle vibrated by the vibration apparatus,
   generates an adjustment vibration signal for making the vehicle body vibration signal coincide with the target vibration signal, and
   updates the drive signal on the basis of the adjustment vibration signal so that the vibration apparatus vibrates the vehicle with the target vibration signal.
(2) The vibration control apparatus according to (1), in which
the vibration signal selection unit selects the target vibration signal in accordance with audiovisual content viewed by a passenger of the vehicle.
(3) The vibration control apparatus according to (2), in which
the vibration signal selection unit selects, as the target vibration signal, any one of
a vibration signal generated on the basis of a video signal of the audiovisual content,
a vibration signal generated on the basis of an audio signal of the audiovisual content,
a vibration signal associated with the audiovisual content, or
a preset vibration signal not depending on the audiovisual content.
(4) The vibration control apparatus according to (2) or (3), in which
the vibration signal selection unit selects, as the target vibration signal, a single preset vibration signal selected from a plurality of preset vibration signals on the basis of a genre of the audiovisual content.
(5) The vibration control apparatus according to any one of (1) to (4), further including
a safety management unit that stops the vibration apparatus when detecting rotation of a rear wheel of the vehicle or open of a door.
(6) The vibration control apparatus according to any one of (1) to (5), further including
a displacement measurement device that measures a displacement amount of the vehicle vibrated, in which
the drive signal generation unit obtains the vehicle body vibration signal based on the displacement amount.
(7) The vibration control apparatus according to any one of (1) to (6), further including
the vibration apparatus.
(8) The vibration control apparatus according to any one of (1) to (7), in which
the vibration apparatus is installed at a stop position of the vehicle and rotates a front wheel while restricting a movement of the vehicle due to rotation of the front wheel of the vehicle, thereby vibrating the vehicle.
(9) The vibration control apparatus according to (8), in which
the vibration apparatus includes
   a stopper that restricts a movement in a single direction of the front wheel of the vehicle,
   a pushing unit that pushes the front wheel whose movement in the single direction is restricted in the single direction, thereby rotating the front wheel to vibrate the vehicle, and
   an actuator that drives the pushing unit.
(10) The vibration control apparatus according to any one of (1) to (7), in which
the vibration apparatus vibrates a jack-up point of the vehicle.
(11) The vibration control apparatus according to any one of (1) to (10), in which
the vibration apparatus is a self-propelled-type vibration apparatus including
   an image sensor,
   a self-propelled mechanism,
   an actuator, and
   a driving unit that
      detects a vibration point from a sensing result of the image sensor,
      controls the self-propelled mechanism in order to move by its own power to a vibration position for vibrating the detected vibration point, and
      controls the actuator to vibrate the vibration point from the vibration position.
(12) A vibration control method, including:
selecting a target vibration signal that is a target vibration waveform;
generating a drive signal to be output to a vibration apparatus in order for the vibration apparatus that comes into contact with a vehicle and vibrating the vehicle from outside to vibrate the vehicle with the target vibration signal;
obtaining a vehicle body vibration signal that is a vibration signal of the vehicle vibrated by the vibration apparatus;
generating an adjustment vibration signal for making the vehicle body vibration signal coincide with the target vibration signal; and
updating the drive signal on the basis of the adjustment vibration signal so that the vibration apparatus vibrates the vehicle with the target vibration signal.
(13) A control system, including:
a vibration apparatus that comes into contact with a vehicle and vibrates the vehicle from outside; and
a vibration control apparatus including
   a vibration signal selection unit that selects a target vibration signal that is a target vibration waveform, and
   a drive signal generation unit that
      generates a drive signal to be output to a vibration apparatus in order for the vibration apparatus to vibrate the vehicle with the target vibration signal,
      obtains a vehicle body vibration signal that is a vibration signal of the vehicle vibrated by the vibration apparatus,
      generates an adjustment vibration signal for making the vehicle body vibration signal coincide with the target vibration signal, and
      updates the drive signal on the basis of the adjustment vibration signal so that the vibration apparatus vibrates the vehicle with the target vibration signal.
(14) The control system according to (13), further including
a content reproduction apparatus that reproduces audiovisual content and outputs the audiovisual content to a content output apparatus by which a passenger of the vehicle is capable of viewing the audiovisual content, in which
the vibration control apparatus controls the vibration apparatus so that the vibration apparatus vibrates the vehicle while the content reproduction apparatus is reproducing the audiovisual content.
(15) The control system according to (13) or (14), further including
charging equipment of an electric vehicle that is the vehicle, in which
the vibration control apparatus controls the vibration apparatus so that the vibration apparatus vibrates the vehicle while charging the vehicle from the charging equipment.
(16) A vibration apparatus controlled by a vibration control apparatus including
   a vibration signal selection unit that selects a target vibration signal that is a target vibration waveform, and
   a drive signal generation unit that
      generates a drive signal to be output to a vibration apparatus in order for the vibration apparatus that comes into contact with a vehicle and vibrates the vehicle from outside to vibrate the vehicle with the target vibration signal,
      obtains a vehicle body vibration signal that is a vibration signal of the vehicle vibrated by the vibration apparatus,
      generates an adjustment vibration signal for making the vehicle body vibration signal coincide with the target vibration signal, and
      updates the drive signal on the basis of the adjustment vibration signal so that the vibration apparatus vibrates the vehicle with the target vibration signal.

Although the embodiments and modified examples of the present technology have been described, the present technology is not limited only to the above-mentioned embodiments and can be variously modified without departing from the gist of the present technology as a matter of course.

### REFERENCE SIGNS LIST

1 vehicle
10 control system
12 front wheel
13 jack-up point
200 charging equipment
300 content reproduction apparatus
400 content output apparatus
500 vibration apparatus
600 vibration control apparatus
601 drive signal output unit
602 vibration signal selection unit
603 video vibration signal generation unit
604 audio vibration signal generation unit
605 drive signal generation unit
606 displacement measurement device
607 Fourier transform device
610 vehicle position determination device
611 vehicle imaging unit
612 stop position measurement unit
613 stop position determination unit
614 determination display unit
615 wheel-fixing device control unit
616 wheel lock mechanism
620 safety management unit
621 image sensor
622 illumination
623 image recognition unit
624 wheel operation detection unit
625 emergency stop signal generation unit
626 door open/close operation detection unit
627 area sensor
628 vehicle periphery monitoring unit
629 emergency stop button
700 driving unit
701 vehicle imaging unit
702 vehicle type identification unit
703 vehicle data acquisition unit
704 vehicle stop position measurement unit
705 environment map generation unit
706 route computing unit
707 control amount computing unit
708 driving control
709 brake control
710 vehicle bottom imaging unit
711 self-position estimation unit
712 inertial information acquisition unit
713 motion estimation unit
714 illumination apparatus

1. A vibration control apparatus, comprising:
a vibration signal selection unit that selects a target vibration signal that is a target vibration waveform; and
a drive signal generation unit that
generates a drive signal to be output to a vibration apparatus in order for the vibration apparatus that comes into contact with a vehicle and vibrates the vehicle from outside to vibrate the vehicle with the target vibration signal,
obtains a vehicle body vibration signal that is a vibration signal of the vehicle vibrated by the vibration apparatus,
generates an adjustment vibration signal for making the vehicle body vibration signal coincide with the target vibration signal, and
updates the drive signal on a basis of the adjustment vibration signal so that the vibration apparatus vibrates the vehicle with the target vibration signal.

2. The vibration control apparatus according to claim 1, wherein
the vibration signal selection unit selects the target vibration signal in accordance with audiovisual content viewed by a passenger of the vehicle.

3. The vibration control apparatus according to claim 2, wherein
the vibration signal selection unit selects, as the target vibration signal, any one of
a vibration signal generated on a basis of a video signal of the audiovisual content,
a vibration signal generated on a basis of an audio signal of the audiovisual content,
a vibration signal associated with the audiovisual content, or
a preset vibration signal not depending on the audiovisual content.

4. The vibration control apparatus according to claim 2, wherein
the vibration signal selection unit selects, as the target vibration signal, a single preset vibration signal selected from a plurality of preset vibration signals on a basis of a genre of the audiovisual content.

5. The vibration control apparatus according to claim 1, further comprising
a safety management unit that stops the vibration apparatus when detecting rotation of a rear wheel of the vehicle or open of a door.

6. The vibration control apparatus according to claim 1, further comprising
a displacement measurement device that measures a displacement amount of the vehicle vibrated, wherein
the drive signal generation unit obtains the vehicle body vibration signal based on the displacement amount.

7. The vibration control apparatus according to claim 1, further comprising
the vibration apparatus.

8. The vibration control apparatus according to claim 1, wherein
the vibration apparatus is installed at a stop position of the vehicle and rotates a front wheel while restricting a movement of the vehicle due to rotation of the front wheel of the vehicle, thereby vibrating the vehicle.

9. The vibration control apparatus according to claim 8, wherein
the vibration apparatus includes
a stopper that restricts a movement in a single direction of the front wheel of the vehicle,
a pushing unit that pushes the front wheel whose movement in the single direction is restricted in the single direction, thereby rotating the front wheel to vibrate the vehicle, and
an actuator that drives the pushing unit.

10. The vibration control apparatus according to claim 1, wherein
the vibration apparatus vibrates a jack-up point of the vehicle.

11. The vibration control apparatus according to claim 1, wherein
the vibration apparatus is a self-propelled-type vibration apparatus including
an image sensor,
a self-propelled mechanism,
an actuator, and
a driving unit that
detects a vibration point from a sensing result of the image sensor,
controls the self-propelled mechanism in order to move by its own power to a vibration position for vibrating the detected vibration point, and
controls the actuator to vibrate the vibration point from the vibration position.

12. A vibration control method, comprising:
selecting a target vibration signal that is a target vibration waveform;
generating a drive signal to be output to a vibration apparatus in order for the vibration apparatus that comes into contact with a vehicle and vibrating the vehicle from outside to vibrate the vehicle with the target vibration signal;
obtaining a vehicle body vibration signal that is a vibration signal of the vehicle vibrated by the vibration apparatus;
generating an adjustment vibration signal for making the vehicle body vibration signal coincide with the target vibration signal; and
updating the drive signal on a basis of the adjustment vibration signal so that the vibration apparatus vibrates the vehicle with the target vibration signal.

13. A control system, comprising:
a vibration apparatus that comes into contact with a vehicle and vibrates the vehicle from outside; and
a vibration control apparatus including
a vibration signal selection unit that selects a target vibration signal that is a target vibration waveform, and
a drive signal generation unit that
generates a drive signal to be output to a vibration apparatus in order for the vibration apparatus to vibrate the vehicle with the target vibration signal,
obtains a vehicle body vibration signal that is a vibration signal of the vehicle vibrated by the vibration apparatus,
generates an adjustment vibration signal for making the vehicle body vibration signal coincide with the target vibration signal, and
updates the drive signal on a basis of the adjustment vibration signal so that the vibration apparatus vibrates the vehicle with the target vibration signal.

14. The control system according to claim 13, further comprising
a content reproduction apparatus that reproduces audiovisual content and outputs the audiovisual content to a content output apparatus by which a passenger of the vehicle is capable of viewing the audiovisual content, wherein
the vibration control apparatus controls the vibration apparatus so that the vibration apparatus vibrates the vehicle while the content reproduction apparatus is reproducing the audiovisual content.

15. The control system according to claim 13, further comprising
charging equipment of an electric vehicle that is the vehicle, wherein
the vibration control apparatus controls the vibration apparatus so that the vibration apparatus vibrates the vehicle while charging the vehicle from the charging equipment.

16. A vibration apparatus controlled by a vibration control apparatus including
a vibration signal selection unit that selects a target vibration signal that is a target vibration waveform, and
a drive signal generation unit that
generates a drive signal to be output to a vibration apparatus in order for the vibration apparatus that comes into contact with a vehicle and vibrates the vehicle from outside to vibrate the vehicle with the target vibration signal,
obtains a vehicle body vibration signal that is a vibration signal of the vehicle vibrated by the vibration apparatus,
generates an adjustment vibration signal for making the vehicle body vibration signal coincide with the target vibration signal, and
updates the drive signal on a basis of the adjustment vibration signal so that the vibration apparatus vibrates the vehicle with the target vibration signal.
